(19) United States
(12) Patent Application Publication
(10) Pub. No.: US 2024/0425623 A1
(43) Pub. Date: Dec. 26, 2024

(54) DUAL CATALYST COMPOSITIONS

(71) Applicants: TOTALENERGIES ONETECH BELGIUM, Seneffe (BE); UNIVERSITE DE RENNES, RENNES (FR); CENTRE NATIONAL DE LA RECHERCHE SCIENTIFIQUE, Paris (FR)

(72) Inventors: Kaitie GIFFIN, Seneffe (BE); Jean-François CARPENTIER, Rennes Cedex (FR); Evgueni KIRILLOV, Rennes Cedex (FR); Alexandre WELLE, Seneffe (BE); Virginie CIRRIEZ, Seneffe (BE)

(73) Assignees: TOTALENERGIES ONETECH BELGIUM, Seneffe (BE); UNIVERSITE DE RENNES, RENNES (FR); CENTRE NATIONAL DE LA RECHERCHE SCIENTIFIQUE, Paris (FR)

(21) Appl. No.: 18/702,930

(22) PCT Filed: Nov. 30, 2022
(86) PCT No.: PCT/EP2022/083779

§ 371 Date: Apr. 19, 2024

(30) Foreign Application Priority Data
Dec. 1, 2021 (EP) 21306684.8

(51) Int. Cl. C08F 10/02

(52) U.S. Cl. CPC C08F 10/02; C08F 2420/10

(57) ABSTRACT

The present invention relates to a catalyst composition comprising: catalyst component A comprising the meso form of a bridged metallocene compound with two indenyl groups, each indenyl being independently substituted with one or more substituents, wherein at least one of the substituents is on position 3 and/or 5 of each indenyl, and wherein at least one of the substituents is an aryl or heteroaryl; wherein the meso/rac ratio of the meso form of the bridged metallocene compound of catalyst component A is 95:5 or greater, as determined using ¹H NMR; preferably wherein the aryl or heteroaryl substituent is on the 3-position of each indenyl; catalyst component B comprising a bridged metallocene compound with two indenyl groups, each indenyl being independently substituted with one or more substituents, wherein at least one of the substituents is an unsubstituted or substituted aryl or heteroaryl; and wherein the unsubstituted or substituted aryl or heteroaryl is not on position 3 and/or 5 of the indenyl; and an optional activator; an optional support; and an optional co-catalyst. The present invention also relates to a polymerization process using said composition. The invention further relates to olefin polymers at least partially catalyzed by said catalyst composition and articles comprising said olefin polymers.

### FIELD OF INVENTION

The invention relates to the new dual catalyst compositions, in particular dual site catalyst compositions for polymerization reactions.

### BACKGROUND OF THE INVENTION

In the field of polymer, constant mechanical properties improvement is mandatory. It was achieved in the last few years using metallocene catalyst combined with cascade reactor to make tailor made bimodal resins. However, the requirement of multiple reactors leads to increased costs for both construction and operation, and this can be overcome using dual-site catalyst composition in a single reactor.

In the prior art, the first obvious strategy was multiple separate catalyst injection. Although, this process showed high flexibility, several drawbacks can be highlighted: multiple catalysts injections lead to increased costs and polymer homogeneity was difficult to achieve.

The strategy of using a dual-site catalyst in a single reactor seemed therefore to be a good alternative. However, this technology suffers from the difficulty to control properly the heterogenization and more importantly the activation. This might be related to the different behavior of metallocene during the heterogenization process typically leading to a dominating structure while others seem inactive. Moreover, in several examples in the literature, some combinations suffer of a lack of reactivity or works only in specific conditions or in a specific process. The challenge is to find the right combination of metallocenes to avoid these drawbacks.

### SUMMARY OF THE INVENTION

It is therefore an object of the present invention to provide a new dual catalyst avoiding the above-mentioned drawbacks.

The present invention provides dual catalyst composition containing a bridged bis-indenyl metallocene having a meso stereoisomer geometry, each indenyl being independently substituted with one or more substituents, preferably wherein at least one of the substituents is on position 3 and/or 5 of each indenyl, preferably on position 3 of each indenyl, and a second catalyst which is a bridged bis-indenyl metallocene, each indenyl of said second catalyst being independently substituted with one or more substituents, wherein the one or more substituents is not on position 3 and/or 5 of each indenyl, preferably wherein at least one of the substituents is on position 2 and/or 4 of each indenyl. It is preferred that each indenyl of the second metallocene is independently substituted with one or more substituents, wherein at least one of the substituents is an unsubstituted or substituted aryl or heteroaryl; wherein the unsubstituted or substituted aryl or heteroaryl is not on position 3 and/or 5 of the indenyl. The new compositions of the present invention give polyethylene products with unique molecular architectures and high density split in a one reactor configuration.

In a first aspect, the present invention provides a catalyst composition comprising: catalyst component A comprising the meso form of a bridged metallocene compound with two indenyl groups, each indenyl being independently substituted with one or more substituents, wherein at least one of the substituents is on position 3 and/or 5 of each indenyl, wherein at least one of the substituents is an aryl or heteroaryl; wherein the meso/rac ratio of the meso form of the bridged metallocene compound of catalyst component A is 95:5 or greater, as determined using ¹H NMR; preferably wherein the aryl or heteroaryl substituent is on the 3-position of each indenyl;
catalyst component B comprising a bridged metallocene compound with two indenyl groups, each indenyl being independently substituted with one or more substituents, wherein at least one of the substituents is an unsubstituted or substituted aryl or heteroaryl; and wherein the unsubstituted or substituted aryl or heteroaryl substituent is not on position 3 and/or 5 of each indenyl, preferably each indenyl has one or more substituents on positions 2 and/or 4 of each indenyl, preferably each indenyl has one substituent on position 2 and one substituent on position 4 of each indenyl, preferably the unsubstituted or substituted aryl or heteroaryl is on position 4 of each indenyl; and
an optional activator; an optional support; and an optional co-catalyst.

In a second aspect, the present invention provides an olefin polymerization process, the process comprising: contacting at least one catalyst composition according to the first aspect, with an olefin monomer, optionally hydrogen, and optionally one or more olefin comonomers; and polymerizing the monomer, and the optionally one or more olefin comonomers, in the presence of the at least one catalyst composition, and optional hydrogen, thereby obtaining a polyolefin.

In a third aspect, the present invention provides, an olefin polymer at least partially catalyzed by at least one catalyst composition according to the first aspect or produced by the process according to the second aspect of the invention.

The present invention also encompasses an article comprising the olefin polymer according to the third aspect.

The invention overcomes the drawbacks of the aforementioned strategies. The invention provides a composition comprising a dual catalyst composition which means a catalyst particle with two metallocene active sites on a single carrier.

Blending occurs on a microscale when using the present composition, leading to improvements in the homogeneity of the resulting product. This has an important effect on processability when very broad bimodal molecular weight distributions are needed. The geometry and substitution patterns of both catalyst components can be used as a means to control desired properties in the resulting bimodal polymers. The catalyst components of the present composition allow producing a polymer with a broad molecular weight distribution and inverse comonomer incorporation.

After the polymer is produced, it may be formed into various articles, including but not limited to, film products, caps and closures, rotomoulding, grass yarn, pressure/temperature resistant pipes etc.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature or statement indicated as being preferred or advantageous may be combined with any other features or statements indicated as being preferred or advantageous.

### BRIEF DESCRIPTION OF THE FIGURES

FIG. 1 represents a graph plotting the ¹³C{¹H} NMR spectrum of a metallocene ethylene polymer.

FIG. 2 represents a graph plotting the ¹H NMR spectrum of meso-Met 1 (mMet1).

FIG. 3 represents a graph plotting the GPC traces of the polymers obtained with mMet1/Met2 compositions with varying weight ratio of each catalyst.

FIG. 4 represents a graph plotting the GPC traces of the polymer obtained with a catalyst composition having a 20/80 mMet1/Met2 weight ratio as a function of hydrogen concentration.

FIG. 5 represents a graph plotting the GPC trace of the polymers obtained with a catalyst composition having a 20/80 mMet1/Met3 weight ratio.

### DETAILED DESCRIPTION OF THE INVENTION

Before the present compounds, processes, articles, and uses encompassed by the invention are described, it is to be understood that this invention is not limited to particular compositions, compounds, processes, articles, and uses described, as such compositions compounds, processes, articles, and uses may, of course, vary. It is also to be understood that the terminology used herein is not intended to be limiting, since the scope of the present invention will be limited only by the appended claims.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. When describing the compounds, processes, articles, and uses of the invention, the terms used are to be construed in accordance with the following definitions, unless the context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g., from 1.0 to 5.0 includes both 1.0 and 5.0). Any numerical range recited herein is intended to include all sub-ranges subsumed therein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims and statements, any of the embodiments can be used in any combination.

Whenever the term “substituted” is used herein, it is meant to indicate that one or more hydrogen atoms on the atom indicated in the expression using “substituted” is replaced with a selection from the indicated group, provided that the indicated atom's normal valence is not exceeded, and that the substitution results in a chemically stable compound, i.e., a compound that is sufficiently robust to survive isolation from a reaction mixture. Preferred substituents for the indenyl, cyclopentadienyl and fluorenyl groups, can be selected from the group comprising alkyl, alkenyl, cycloalkyl, aryl, alkoxy, alkylaryl, arylalkyl, halogen, Si(R¹⁰)₃, heteroalkyl; wherein each R¹⁰ is independently hydrogen, alkyl, or alkenyl. Preferably, each indenyl is substituted with at least one aryl or heteroaryl, more preferably aryl; preferably wherein the aryl or heteroaryl substituent is on the 3-position of each indenyl; the indenyl can be further substituted with one or more substituents selected from the group comprising alkyl, alkenyl, cycloalkyl, aryl, alkoxy, alkylaryl, arylalkyl, halogen, Si(R¹⁰)₃, heteroalkyl; wherein each R¹⁰ is independently hydrogen, alkyl, or alkenyl.

The term “halo” or “halogen” as a group or part of a group is generic for fluoro, chloro, bromo, iodo.

The term “alkyl” as a group or part of a group, refers to a hydrocarbyl group of formula CₙH₂ₙ₊₁ wherein n is a number greater than or equal to 1. Alkyl groups may be linear or branched and may be substituted as indicated herein. Generally, alkyl groups of this invention comprise from 1 to 20 carbon atoms, preferably from 1 to 10 carbon atoms, preferably from 1 to 6 carbon atoms, more preferably from 1 to 4 carbon atoms. When a subscript is used herein following a carbon atom, the subscript refers to the number of carbon atoms that the named group may contain. For example, the term “C₁₋₂₀alkyl”, as a group or part of a group, refers to a hydrocarbyl group of formula —CₙH₂ₙ₊₁ wherein n is a number ranging from 1 to 20. Thus, for example, “C₁₈ alkyl” includes all linear or branched alkyl groups with between 1 and 8 carbon atoms, and thus includes methyl, ethyl, n-propyl, i-propyl, butyl and its isomers (e.g., n-butyl, i-butyl and t-butyl); pentyl and its isomers, hexyl and its isomers, etc. A “substituted alkyl” refers to an alkyl group substituted with one or more substituent(s) (for example 1 to 3 substituent(s), for example 1, 2, or 3 substituent(s)) at any available point of attachment.

When the suffix “ene” is used in conjunction with an alkyl group, i.e., “alkylene”, this is intended to mean the alkyl group as defined herein having two single bonds as points of attachment to other groups. As used herein, the term “alkylene” also referred as “alkanediyl”, by itself or as part of another substituent, refers to alkyl groups that are divalent, i.e., with two single bonds for attachment to two other groups. Alkylene groups may be linear or branched and may be substituted as indicated herein. Non-limiting examples of alkylene groups include methylene (—CH₂—), ethylene (—CH₂—CH₂—), methylmethylene (—CH(CH₃)—), 1-methyl-ethylene (—CH(CH₃)—CH₂—), n-propylene (—CH₂—CH₂—CH₂—), 2-methylpropylene (—CH₂—CH(CH₃)—CH₂—), 3-methylpropylene (—CH₂—CH₂—CH(CH₃)—), n-butylene (—CH₂—CH₂—CH₂—CH₂—), 2-methylbutylene (—CH₂—CH(CH₃)—CH₂—CH₂—), 4-methylbutylene (—CH₂—CH₂—CH₂—CH(CH₃)—), pentylene and its chain isomers, hexylene and its chain isomers.

The term “alkenyl” as a group or part of a group, refers to an unsaturated hydrocarbyl group, which may be linear, or branched, comprising one or more carbon-carbon double bonds.

Generally, alkenyl groups of this invention comprise from 3 to 20 carbon atoms, preferably from 3 to 10 carbon atoms, preferably from 3 to 8 carbon atoms. When a subscript is used herein following a carbon atom, the subscript refers to the number of carbon atoms that the named group may contain. Examples of C₃₋₂₀alkenyl groups are ethenyl, 2-propenyl, 2-butenyl, 3-butenyl, 2-pentenyl and its isomers, 2-hexenyl and its isomers, 2,4-pentadienyl, and the like.

The term “alkoxy” or “alkyloxy”, as a group or part of a group, refers to a group having the formula —OR^{b} wherein R^{b} is alkyl as defined herein above. Non-limiting examples of suitable alkoxy include methoxy, ethoxy, propoxy, isopropoxy, n-butoxy, isobutoxy, sec-butoxy, tert-butoxy, pentyloxy and hexyloxy.

The term “cycloalkyl”, as a group or part of a group, refers to a cyclic alkyl group, that is a monovalent, saturated, hydrocarbyl group having 1 or more cyclic structure, and comprising from 3 to 20 carbon atoms, more preferably from 3 to 10 carbon atoms, more preferably from 3 to 8 carbon atoms; more preferably from 3 to 6 carbon atoms. Cycloalkyl includes all saturated hydrocarbon groups containing 1 or more rings, including monocyclic, bicyclic groups or tricyclic. The further rings of multi-ring cycloalkyls may be either fused, bridged and/or joined through one or more spiro atoms. When a subscript is used herein following a carbon atom, the subscript refers to the number of carbon atoms that the named group may contain. For example, the term “C₃₋₂₀cycloalkyl”, a cyclic alkyl group comprising from 3 to 20 carbon atoms. For example, the term “C₃₋₁₀cycloalkyl”, a cyclic alkyl group comprising from 3 to 10 carbon atoms. For example, the term “C₃₋₈cycloalkyl”, a cyclic alkyl group comprising from 3 to 8 carbon atoms. For example, the term “C₃₋₆cycloalkyl”, a cyclic alkyl group comprising from 3 to 6 carbon atoms. Examples of C₃₋₁₂cycloalkyl groups include but are not limited to adamantly, cyclopropyl, cyclobutyl, cyclopentyl, cyclohexyl, cycloheptyl, cyclooctyl, bicycle[2.2.1]heptan-2yl, (1S,4R)-norbornan-2-yl, (1R,4R)-norbornan-2-yl, (1S,4S)-norbornan-2-yl, (1R,4S)-norbornan-2-yl.

When the suffix “ene” is used in conjunction with a cycloalkyl group, i.e., cycloalkylene, this is intended to mean the cycloalkyl group as defined herein having two single bonds as points of attachment to other groups. Non-limiting examples of “cycloalkylene” include 1,2-cyclopropylene, 1,1-cyclopropylene, 1,1-cyclobutylene, 1,2-cyclobutylene, 1,3-cyclopentylene, 1,1-cyclopentylene, and 1,4-cyclohexylene.

Where an alkylene or cycloalkylene group is present, connectivity to the molecular structure of which it forms part may be through a common carbon atom or different carbon atom. To illustrate this applying the asterisk nomenclature of this invention, a C₃alkylene group may be for example *—CH₂CH₂CH₂—*, *—CH(—CH₂CH₃)—* or *—CH₂CH(—CH₃)—*. Likewise, a C₃cycloalkylene group may be

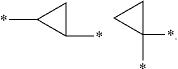

The term “cycloalkenyl” as a group or part of a group, refers to a non-aromatic cyclic alkenyl group, with at least one site (usually 1 to 3, preferably 1) of unsaturation, namely a carbon-carbon, sp2 double bond; preferably having from 5 to 20 carbon atoms more preferably from 5 to 10 carbon atoms, more preferably from 5 to 8 carbon atoms, more preferably from 5 to 6 carbon atoms. Cycloalkenyl includes all unsaturated hydrocarbon groups containing 1 or more rings, including monocyclic, bicyclic or tricyclic groups. The further rings may be either fused, bridged and/or joined through one or more spiro atoms. When a subscript is used herein following a carbon atom, the subscript refers to the number of carbon atoms that the named group may contain. For example, the term “C₅₋₂₀cycloalkenyl”, a cyclic alkenyl group comprising from 5 to 20 carbon atoms. For example, the term “C₅₋₁₀cycloalkenyl”, a cyclic alkenyl group comprising from 5 to 10 carbon atoms. For example, the term “C₅₋₈cycloalkenyl”, a cyclic alkenyl group comprising from 5 to 8 carbon atoms. For example, the term “C₅₋₆cycloalkyl”, a cyclic alkenyl group comprising from 5 to 6 carbon atoms. Examples include but are not limited to: cyclopentenyl (—C₅H₇), cyclopentenylpropylene, methylcyclohexenylene and cyclohexenyl (—C₆H₉). The double bond may be in the cis or trans configuration.

The term “cycloalkenylalkyl”, as a group or part of a group, means an alkyl as defined herein, wherein at least one hydrogen atom is replaced by at least one cycloalkenyl as defined herein.

The term “cycloalkoxy”, as a group or part of a group, refers to a group having the formula —OR^{h} wherein R^{h} is cycloalkyl as defined herein above.

The term “aryl”, as a group or part of a group, refers to a polyunsaturated, aromatic hydrocarbyl group having a single ring (i.e., phenyl) or multiple aromatic rings fused together (e.g., naphthyl), or linked covalently, typically containing 6 to 20 atoms; preferably 6 to 10, wherein at least one ring is aromatic. The aromatic ring may optionally include one to two additional rings (either cycloalkyl, heterocyclyl or heteroaryl) fused thereto. Examples of suitable aryl include C₆₋₂₀aryl, preferably C₆₋₁₀aryl, more preferably C₆₋₈aryl. Non-limiting examples of aryl comprise phenyl, biphenylyl, biphenylenyl, or 1- or 2-naphthalenyl; 1-, 2-, 3-, 4-, 5- or 6-tetralinyl (also known as “1,2,3,4-tetrahydronaphtalene); 1-, 2-, 3-, 4-, 5-, 6-, 7- or 8-azulenyl, 4-, 5-, 6 or 7-indenyl; 4- or 5-indanyl; 5-, 6-, 7- or 8-tetrahydronaphthyl; 1,2,3,4-tetrahydronaphthyl; and 1,4-dihydronaphthyl; 1-, 2-, 3-, 4- or 5-pyrenyl. A “substituted aryl” refers to an aryl group having one or more substituent(s) (for example 1, 2 or 3 substituent(s), or 1 to 2 substituent(s)), at any available point of attachment.

The term “aryloxy”, as a group or part of a group, refers to a group having the formula —OR⁹ wherein R⁹ is aryl as defined herein above.

The term “arylalkyl”, as a group or part of a group, means an alkyl as defined herein, wherein at least one hydrogen atom is replaced by at least one aryl as defined herein. Non-limiting examples of arylalkyl group include benzyl, phenethyl, dibenzylmethyl, methylphenylmethyl, 3-(2-naphthyl)-butyl, and the like.

The term “alkylaryl” as a group or part of a group, means an aryl as defined herein wherein at least one hydrogen atom is replaced by at least one alkyl as defined herein. Non-limiting example of alkylaryl group include p-CH₃—R^{g}—, wherein R^{g} is aryl as defined herein above.

The term “arylalkyloxy” or “aralkoxy” as a group or part of a group, refers to a group having the formula —O—R^{a}—R^{g} wherein R^{g} is aryl, and R^{g} is alkylene as defined herein above.

The term “heteroalkyl” as a group or part of a group, refers to an acyclic alkyl wherein one or more carbon atoms are replaced by at least one heteroatom selected from the group comprising O, Si, S, B, and P, with the proviso that said chain may not contain two adjacent heteroatoms. This means that one or more —CH₃ of said acyclic alkyl can be replaced by —OH for example and/or that one or more —CR₂— of said acyclic alkyl can be replaced by O, Si, S, B, and P.

The term “aminoalkyl” as a group or part of a group, refers to the group —Rⱼ—NR^{k}R^{l} wherein R^{j} is alkylene, R^{k} is hydrogen or alkyl as defined herein, and R^{l} is hydrogen or alkyl as defined herein.

The term “heterocyclyl” as a group or part of a group, refers to non-aromatic, fully saturated or partially unsaturated cyclic groups (for example, 3 to 7 membered monocyclic, 7 to 11 membered bicyclic, or containing a total of 3 to 10 ring atoms) which have at least one heteroatom in at least one carbon atom-containing ring. Each ring of the heterocyclic group containing a heteroatom may have 1, 2, 3 or 4 heteroatoms selected from N, S, Si, Ge, where the nitrogen and sulfur heteroatoms may optionally be oxidized and the nitrogen heteroatoms may optionally be quaternized. The heterocyclic group may be attached at any heteroatom or carbon atom of the ring or ring system, where valence allows. The rings of multi-ring heterocycles may be fused, bridged and/or joined through one or more spiro atoms.

Non limiting exemplary heterocyclic groups include aziridinyl, oxiranyl, thiiranyl, piperidinyl, azetidinyl, 2-imidazolinyl, pyrazolidinyl imidazolidinyl, isoxazolinyl, oxazolidinyl, isoxazolidinyl, thiazolidinyl, isothiazolidinyl, piperidinyl, succinimidyl, 3H-indolyl, indolinyl, isoindolinyl, 2H-pyrrolyl, 1-pyrrolinyl, 2-pyrrolinyl, 3-pyrrolinyl, pyrrolidinyl, 4H-quinolizinyl, 2-oxopiperazinyl, piperazinyl, homopiperazinyl, 2-pyrazolinyl, 3-pyrazolinyl, tetrahydro-2H-pyranyl, 2H-pyranyl, 4H-pyranyl, 3,4-dihydro-2H-pyranyl, oxetanyl, thietanyl, 3-dioxolanyl, 1,4-dioxanyl, 2,5-dioximidazolidinyl, 2-oxopiperidinyl, 2-oxopyrrolodinyl, indolinyl, tetrahydropyranyl, tetrahydrofuranyl, tetrahydrothiophenyl, tetrahydroquinolinyl, tetrahydroisoquinolin-1-yl, tetrahydroisoquinolin-2-yl, tetrahydroisoquinolin-3-yl, tetrahydroisoquinolin-4-yl, thiomorpholin-4-yl, thiomorpholin-4-ylsulfoxide, thiomorpholin-4-ylsulfone, 1,3-dioxolanyl, 1,4-oxathianyl, 1,4-dithianyl, 1,3,5-trioxanyl, 1H-pyrrolizinyl, tetrahydro-1,1-dioxothiophenyl, N-formylpiperazinyl, and morpholin-4-yl.

Whenever used in the present invention the term “compounds” or a similar term is meant to include the compounds of general formula (I) and/or (II) and any subgroup thereof, including all polymorphs and crystal habits thereof, and isomers thereof (including optical, geometric and tautomeric isomers) as hereinafter defined.

The compounds of formula (I) and/or (II) or any subgroups thereof may comprise alkenyl group, and the geometric cis/trans (or Z/E) isomers are encompassed herein. Where structural isomers are interconvertible via a low energy barrier, tautomeric isomerism (‘tautomerism’) can occur. This can take the form of proton tautomerism in compounds of formula (I) containing, for example, a keto group, or so-called valence tautomerism in compounds which contain an aromatic moiety. It follows that a single compound may exhibit more than one type of isomerism.

Cis/trans isomers may be separated by conventional techniques well known to those skilled in the art, for example, chromatography and fractional crystallization.

Preferred statements (features) and embodiments of the compositions, processes, polymers, articles, and uses of this invention are set herein below. Each statement and embodiment of the invention so defined may be combined with any other statement and/or embodiment, unless clearly indicated to the contrary. In particular, any feature indicated as being preferred or advantageous may be combined with any other features or statements indicated as being preferred or advantageous. Hereto, the present invention is in particular captured by any one or any combination of one or more of the below numbered statements and embodiments, with any other aspect and/or embodiment.
1. A catalyst composition comprising:
   catalyst component A comprising the meso form of a bridged metallocene compound with two indenyl groups, each indenyl being independently substituted with one or more substituents, wherein at least one of the substituents is on position 3 and/or 5 of each indenyl, and wherein at least one of the substituents is an aryl or heteroaryl, preferably wherein the meso/rac ratio of the meso form of the bridged metallocene compound of catalyst component A is preferably 95:5 or greater, as determined using ¹H NMR; preferably at least one of the substituents is aryl; preferably each indenyl has one substituent on position 3, preferably each indenyl has one substituent on position 5, yet more preferably each indenyl has one substituent on position 3 and one substituent on position 5 of each indenyl, preferably the aryl or heteroaryl substituent is on 3-position of each indenyl;
   catalyst component B comprising a bridged metallocene compound with two indenyl groups, each indenyl being independently substituted with one or more substituents, wherein at least one of the substituents is an unsubstituted or substituted aryl or heteroaryl; and wherein the unsubstituted or substituted aryl or heteroaryl is not on position 3 and/or 5 of each indenyl, preferably not on position 3 and 5 of each indenyl; preferably each indenyl has one or more substituents on positions 2 and/or 4 of each indenyl, preferably each indenyl has one substituent on position 2, preferably each indenyl has one substituent on position 4, yet more preferably each indenyl has one substituent on position 2 and one substituent on position 4 of each indenyl, preferably the unsubstituted or substituted aryl or heteroaryl is on position 4 of each indenyl; and
   an optional activator; an optional support; and an optional co-catalyst.
2. A catalyst composition comprising:
   catalyst component A comprising the meso form of a bridged metallocene compound with two indenyl groups, each indenyl being independently substituted with one or more substituents, wherein at least one of the substituents is on position 3 and/or 5 of each indenyl, wherein at least one of the substituents is an aryl or heteroaryl, preferably wherein the meso/rac ratio of the meso form of the bridged metallocene compound of catalyst component A is 95:5 or greater, as determined using ¹H NMR; preferably at least one of the substituents is aryl; preferably each indenyl has one substituent on position 3, preferably each indenyl has one substituent on position 5, yet more preferably each indenyl has one substituent on position 3 and one substituent on position 5 of each indenyl, preferably the aryl or heteroaryl substituent is on 3-position of each indenyl;
   catalyst component B comprising a bridged metallocene compound with two indenyl groups, each indenyl being independently substituted with one or more substituents, wherein at least one of the substituents is an unsubstituted or substituted aryl or heteroaryl; each indenyl having at least one substituent on positions 2 and/or 4 of each indenyl, preferably each indenyl has one substituent on position 2, preferably each indenyl has one substituent on position 4, yet more preferably each indenyl has one substituent on position 2 and one substituent on position 4 of each indenyl, preferably said unsubstituted or substituted aryl substituent on position 4 of each indenyl; and
   an optional activator; an optional support; and an optional co-catalyst.
3. A catalyst composition comprising:
   catalyst component A comprising the meso form of a bridged metallocene compound with two indenyl groups, each indenyl being independently substituted with one or more substituents, wherein at least one of the substituents is on position 3 and/or 5 of each indenyl, wherein at least one of the substituents is an aryl or heteroaryl, preferably wherein the meso/rac ratio of the meso form of the bridged metallocene compound of catalyst component A is 95:5 or greater, as determined using ¹H NMR; preferably at least one of the substituents is aryl; preferably each indenyl has one substituent on position 3, preferably each indenyl has one substituent on position 5, yet more preferably each indenyl has one substituent on position 3 and one substituent on position 5 of each indenyl, preferably the aryl or heteroaryl substituent is on 3-position of each indenyl;
   catalyst component B comprising a bridged metallocene compound with two indenyl groups, each indenyl being independently substituted with two or more substituents, wherein one substituent is on position 2 of each indenyl, and one other substituent is on position 4 of each indenyl, preferably wherein at least one of the substituents is an unsubstituted or substituted aryl or heteroaryl; preferably wherein the unsubstituted or substituted aryl or heteroaryl is on the 4-position of each indenyl; preferably wherein the other substituents are not on position 3 and/or 5 of the indenyl; and
   an optional activator; an optional support; and an optional co-catalyst.
4. A catalyst composition comprising:
   catalyst component A comprising the meso form of a bridged metallocene compound with two indenyl groups, each indenyl being independently substituted with one or more substituents, wherein at least one of the substituents is on position 3 and/or 5 of each indenyl, wherein at least one of the substituents is an aryl or heteroaryl, preferably wherein the meso/rac ratio of the meso form of the bridged metallocene compound of catalyst component A is 95:5 or greater, as determined using ¹H NMR; preferably at least one of the substituents is aryl; preferably each indenyl has one substituent on position 3, preferably each indenyl has one substituent on position 5, yet more preferably each indenyl has one substituent on position 3 and one substituent on position 5 of each indenyl, preferably the aryl or heteroaryl substituent is on 3-position of each indenyl;
   catalyst component B comprising a bridged metallocene compound with two indenyl groups, each indenyl being independently substituted with one or more substituents, wherein at least one of the substituents is an unsubstituted or substituted aryl or heteroaryl; wherein the unsubstituted or substituted aryl or heteroaryl is on position 4 of each indenyl; and
   an optional activator; an optional support; and an optional co-catalyst.
5. The catalyst composition according to any one of statements 1-4, wherein the meso/rac ratio of the meso form of the bridged metallocene compound of catalyst component A is preferably 95:5 or greater.
6. The composition according to any one of statements 1-5, wherein the weight ratio of catalyst component A to catalyst component B is in a range of from 10/90 to 90/10, preferably in the range of from 10/90 to 80/20, preferably in the range of from 10/90 to 70/30, preferably in the range of from 10/90 to 50/50, preferably in the range of from 10/90 to 40/60.
7. The composition according to any one of statements 1-6, wherein catalyst component A contains a Si, or C bridging atom, optionally substituted with a one or two substituents each independently selected from alkyl, alkenyl, cycloalkyl, or cycloalkenyl.
8. The composition according to any one of statements 1-7, wherein catalyst component B contains a Si, or C bridging atom, optionally substituted with a one or two substituents each independently selected from alkyl, alkenyl, cycloalkyl, or cycloalkenyl.
9. The composition according to any one of statements 1-8, wherein the activator comprises an aluminoxane compound, an organoboron or organoborate compound, an ionizing ionic compound, or any combination thereof, preferably wherein the activator comprises an alumoxane compound.
10. The composition according to any one of statements 1-9, wherein the activator comprises at least one alumoxane compound of formula (V) or (VI)
   R^{a}—(Al(R^{a})—O)ₓ—AlR^{a}₂ (V) for oligomeric, linear alumoxanes; or
   (—Al(R^{a})—O—)_{y} (VI) for oligomeric, cyclic alumoxanes
   wherein x is 1-40, and preferably 10-20;
   wherein y is 3-40, and preferably 3-20; and
   wherein each R^{a} is independently selected from a C₁₋₈alkyl, and preferably is methyl.
11. The composition according to any one of statements 1-10, wherein the activator is methyl alumoxane.
12. The composition according to any one of statements 1-11, wherein the catalyst composition comprises a co-catalyst.
13. The composition according to any one of statements 1-12, wherein the catalyst composition comprises an organoaluminum co-catalyst.
14. The composition according to any one of statements 1-13, wherein the catalyst composition comprises an organoaluminum co-catalyst selected from the group comprising trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and any combination thereof.
15. The composition according to any one of statements 1-14, wherein the support comprises a solid oxide, preferably a solid inorganic oxide, preferably, the solid oxide comprises titanated silica, silica, alumina, silica-alumina, silica-coated alumina, aluminum phosphate, aluminophosphate, heteropolytungstate, titania, zirconia, magnesia, boria, zinc oxide, a mixed oxide thereof, or any mixture thereof; preferably silica, titanated silica, silica treated with fluoride, silica-alumina, alumina treated with fluoride, sulfated alumina, silica-alumina treated with fluoride, sulfated silica-alumina, silica-coated alumina, silica treated with fluoride, sulfated silica-coated alumina, or any combination thereof.
16. The composition according to any one of statements 1-15, wherein the support has a D50 of at most 50 μm, preferably of at most 40 μm, preferably of at most 30 μm. The D50 is defined as the particle size for which fifty percent by weight of the particles has a size lower than the D50. The particle size may be measured by laser diffraction analysis on a Malvern type analyzer.
17. The composition according to any one of statements 1-16, comprising an alumoxane activator; and a titanated silica or silica solid support; and an optional co-catalyst.
18. The composition according to any one of statements 1-17, wherein catalyst component A comprises the meso form of a bridged metallocene catalyst of formula (I), wherein

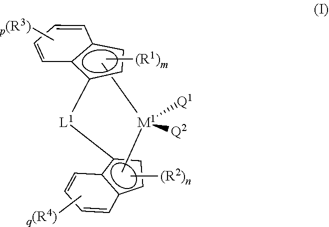

each of R¹, and R³, are independently selected from the group comprising alkyl, alkenyl, cycloalkyl, cycloalkenyl, cycloalkenylalkyl, aryl, alkoxy, alkylaryl, arylalkyl, halogen, Si(R¹⁰)₃, and heteroalkyl; wherein at least one of R¹ or R³ is aryl, wherein each R¹⁰ is independently hydrogen, alkyl, or alkenyl; and m, p, are each independently an integer selected from 0, 1, 2, 3, or 4, wherein at least one of m or p is at least 1;
each of R², and R⁴, are independently selected from the group comprising alkyl, alkenyl, cycloalkyl, cycloalkenyl, cycloalkenylalkyl, phenyl, alkoxy, alkylaryl, arylalkyl, halogen, Si(R¹⁰)₃, and heteroalkyl; wherein at least one of R² or R⁴ is aryl, wherein each R¹⁰ is independently hydrogen, alkyl, or alkenyl; and n, q are each independently an integer selected from 0, 1, 2, 3, or 4, wherein at least one of n or q is at least 1;
L¹ is SiR⁸R⁹, —[CR⁸R⁹]ₕ—, GeR⁸R⁹, or BR⁸; wherein h is an integer selected from 1, 2, or 3;
each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl;
M¹ is a transition metal selected from the group comprising zirconium, titanium, hafnium, and vanadium; and preferably M is zirconium; and
Q¹ and Q² are each independently selected from the group comprising halogen, alkyl, —N(R¹¹)₂, alkoxy, cycloalkoxy, aralkoxy, cycloalkyl, aryl, alkylaryl, aralkyl, and heteroalkyl; wherein R¹¹ is hydrogen or alkyl.
19. The composition according to any one of statements 1-18, wherein the catalyst component A contains a SiR⁸R⁹, or —[CR⁸R⁹]ₕ— bridging group; preferably a SiR⁸R⁹ bridging group; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl, preferably alkyl; or R⁸ and R⁹ together with the atom to which they are attached form a cycloalkyl, cycloalkenyl or heterocyclyl.
20. The composition according to any one of statements 1-19, wherein catalyst component A comprises the meso form of a bridged metallocene of formula (I), wherein

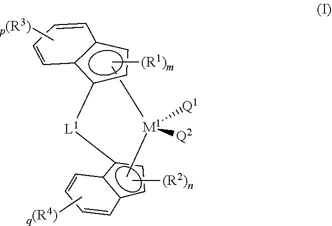

each of R¹, R³ are independently selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl; wherein at least one of R¹ or R³ is C₆₋₂₀aryl, preferably phenyl; wherein each R¹⁰ is independently hydrogen, C₁₋₂₀alkyl, or C₃₋₂₀alkenyl; and m, p, are each independently an integer selected from 0, 1, 2, 3, or 4, wherein at least one of m or p is at least 1;
each of R², R⁴ are independently selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl; wherein at least one of R² or R⁴ is C₆₋₂₀aryl, preferably phenyl; wherein each R¹⁰ is independently hydrogen, C₁₋₂₀alkyl, or C₃₋₂₀alkenyl; and n, q are each independently an integer selected from 0, 1, 2, 3, or 4, wherein at least one of n or q is at least 1;
L¹ is SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, C₁₋₂₀alkyl, C₃₋₂₀alkenyl, C₃₋₂₀ cycloalkyl, C₅₋₂₀cycloalkenyl, C₆₋₂₀cycloalkenylalkyl, C₆₋₁₀aryl, aminoC₁₋₆alkyl, and C₇-C₂₀arylalkyl; or R⁸ and R⁹ together with the atom to which they are attached form a C₃₋₂₀cycloalkyl, C₅₋₂₀cycloalkenyl or heterocyclyl; preferably L¹ is SiR⁸R⁹; each of R⁸, and R⁹ are independently selected from the group comprising hydrogen, C₁₋₂₀alkyl, C₃₋₂₀alkenyl, C₃₋₂₀ cycloalkyl, C₅₋₂₀cycloalkenyl, C₆₋₂₀cycloalkenylalkyl, C₆₋₁₀aryl, aminoC₁₋₆alkyl, and C₇-C₂₀arylalkyl; or R⁸ and R⁹ together with the atom to which they are attached form a C₃₋₂₀cycloalkyl, C₅₋₂₀cycloalkenyl or heterocyclyl; preferably each of R⁸, and R⁹ are independently C₁₋₆alkyl;
M¹ is a transition metal selected from the group comprising zirconium, titanium, hafnium, and vanadium; and preferably M is zirconium; and
Q¹ and Q² are each independently selected from the group consisting of halogen, C₁₋₂₀alkyl, —N(R¹¹)₂, C₁₋₂₀alkoxy, C₃₋₂₀cycloalkoxy, C₇₋₂₀aralkoxy, C₃₋₂₀cycloalkyl, C₆₋₂₀aryl, C₇₋₂₀alkylaryl, C₇₋₂₀aralkyl, and heteroC₁₋₂₀alkyl; wherein R¹¹ is hydrogen or C₁₋₂₀alkyl.
21. The composition according to any one of statements 18-20, wherein
   each of R¹, and R³ are independently selected from the group comprising C₁₋₈alkyl, C₃₋₈alkenyl, C₃₋₈cycloalkyl, C₅₋₈cycloalkenyl, C₆₋₈cycloalkenylalkyl, C₆₋₁₀aryl, C₁₋₈alkoxy, C₇₋₁₂alkylaryl, C₇₋₁₂arylalkyl, halogen, Si(R¹⁰)₃, and heteroC₁₋₈alkyl; wherein at least one of R¹ or R³ is C₆₋₁₀aryl, preferably phenyl; wherein each R¹⁰ is independently hydrogen, C₁₋₈alkyl, or C₃₋₈alkenyl; and m, p, are each independently an integer selected from 0, 1, 2, 3, or 4, wherein at least one of m or p is at least 1;
   each of R², and R⁴, are independently selected from the group comprising C₁₋₈alkyl, C₃₋₈alkenyl, C₃₋₈cycloalkyl, C₅₋₈cycloalkenyl, C₆₋₈cycloalkenylalkyl, C₆₋₁₀aryl, C₁₋₈alkoxy, C₇₋₁₂alkylaryl, C₇₋₁₂arylalkyl, halogen, Si(R¹⁰)₃, and heteroC₁₋₈alkyl; wherein at least one of R² or R⁴ is C₆₋₁₀aryl, preferably phenyl; wherein each R¹⁰ is independently hydrogen, C₁₋₈alkyl, or C₃₋₈alkenyl; and n, q are each independently an integer selected from 0, 1, 2, 3, or 4, wherein at least one of n or q is at least 1;
   L¹ is SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, C₁₋₈ alkyl, C₃₋₈alkenyl, C₃₋₈cycloalkyl, C₅₋₈cycloalkenyl, C₆₋₈cycloalkenylalkyl, C₆₋₁₀aryl, aminoC₁₋₆alkyl, and C₇-C₁₂arylalkyl; or R⁸ and R⁹ together with the atom to which they are attached form a C₃₋₈cycloalkyl, C₅₋₈cycloalkenyl or heterocyclyl; preferably L¹ is SiR⁸R⁹; preferably each of R⁸, and R⁹ are independently selected from hydrogen, or C₁₋₈alkyl;
   M¹ is a transition metal selected from the group comprising zirconium, titanium, hafnium, and vanadium; and preferably M is zirconium; and
   Q¹ and Q² are each independently selected from the group comprising halogen, C₁₋₈alkyl, —N(R¹¹)₂, C₁₋₈alkoxy, C₃₋₈cycloalkoxy, C₇₋₁₂aralkoxy, C₃₋₈cycloalkyl, C₆₋₁₀aryl, C₇₋₁₂alkylaryl, C₇₋₁₂aralkyl, and heteroC₁₋₈alkyl; wherein R¹¹ is hydrogen or C₁₋₈alkyl.
22. The composition according to any one of statements 18-21, wherein
   each of R¹, and R³ are independently selected from the group comprising C₁₋₈alkyl, C₃₋₈alkenyl, C₃₋₈cycloalkyl, C₆₋₁₀aryl, and halogen; wherein at least one of R¹ or R³ is C₆₋₁₀aryl, preferably phenyl; and m, p, are each independently an integer selected from 0, 1, 2, 3, or 4; preferably 0, 1, 2, or 3, preferably 0, 1, or 2; preferably 0, or 1, wherein at least one of m or p is at least 1;
   each of R², and R⁴, are independently selected from the group comprising C₁₋₈alkyl, C₃₋₈alkenyl, C₃₋₈cycloalkyl, C₆₋₁₀aryl, and halogen; wherein at least one of R² or R⁴ is C₆₋₁₀aryl, preferably phenyl; and n, q are each independently an integer selected from 0, 1, 2, 3, or 4; preferably 0, 1, 2, or 3, preferably 0, 1, or 2; preferably 0, or 1, wherein at least one of n or q is at least 1;
   L¹ is SiR⁸R⁹, or —[CR⁸R⁹]ₕ—; wherein h is an integer selected from 1, or 2; each of R⁸, and R⁹ are independently selected from the group comprising hydrogen, C₁₋₈alkyl, C₃₋₈alkenyl, C₃₋₈cycloalkyl; C₅₋₈cycloalkenyl, C₆₋₈cycloalkenylalkyl, and C₆₋₁₀aryl; preferably L¹ is SiR⁸R⁹; preferably each of R⁸, and R⁹ are independently selected from hydrogen, or C₁₋₈alkyl;
   M¹ is a transition metal selected from zirconium, or hafnium; and preferably M is zirconium; and
   Q¹ and Q² are each independently selected from the group comprising halogen, C₁₋₈alkyl, —N(R¹¹)₂, C₆₋₁₀aryl, and C₇₋₁₂aralkyl; wherein R¹¹ is hydrogen or C₁₋₈alkyl, preferably Q¹ and Q² are each independently selected from the group comprising Cl, F, Br, I, methyl, benzyl, and phenyl.
23. The composition according to any one of statements 1-22, wherein catalyst component A comprises the meso form of bridged metallocene of formula (Ia)

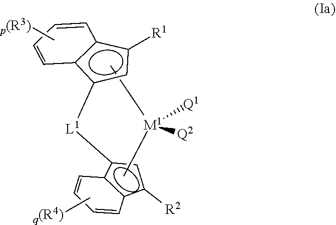

wherein R¹, R², R³, R⁴, L¹, M¹, Q¹, Q², p, and q, have the same meaning as that defined in any one of statements 18-22, preferably wherein R¹ and R² are each independently C₆₋₁₀aryl.
24. The composition according to any one of statements 1-23, wherein catalyst component A comprises the meso form of bridged metallocene of formula (Ib)

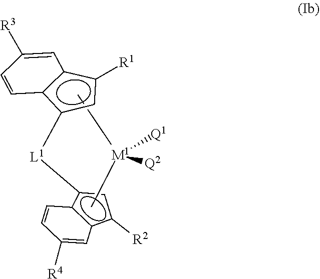

wherein R¹, R², R³, R⁴, L¹, M¹, Q¹, and Q², have the same meaning as that defined in any one of statements 18-22, preferably wherein R¹ and R² are each independently C₆₋₁₀aryl.
25. The composition according to any one of statements 1-24, wherein catalyst component A comprises meso bridged metallocene of formula (Ic)

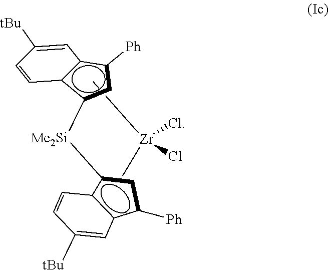

26. The composition to any one of statements 1-25, wherein catalyst component B comprises a bridged metallocene of formula (II), wherein

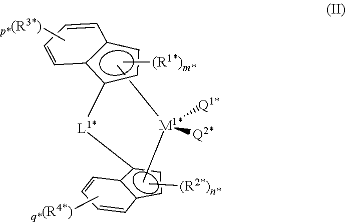

each of R^{1*}, and R^{3*}, are independently selected from the group comprising alkyl, alkenyl, cycloalkyl, cycloalkylalkyl, cycloalkenyl, cycloalkenylalkyl, aryl, alkoxy, alkylaryl, arylalkyl, halogen, Si(R¹⁰)₃, and heteroalkyl; wherein each of said group can be unsubstituted or substituted with one or more substituents each independently selected from the group comprising alkyl, alkenyl, cycloalkyl, cycloalkylalkyl, alkoxy, halogen, haloalkyl; wherein at least one of R^{1*} or R^{3*} is unsubstituted or substituted aryl, wherein R^{1*} is not in position 3 and/or R^{3*} is not on position 5 of each indenyl, wherein each R¹⁰ is independently hydrogen, alkyl, aryl, or alkenyl; and m*, p*, are each independently an integer selected from 0, 1, 2, 3, or 4, wherein at least one of m* or p* is at least 1;
each of R^{2*}, and R^{4*}, are independently selected from the group comprising alkyl, alkenyl, cycloalkyl, cycloalkylalkyl, cycloalkenyl, cycloalkenylalkyl, phenyl, alkoxy, alkylaryl, arylalkyl, halogen, Si(R¹⁰)₃, and heteroalkyl; wherein each of said group can be unsubstituted or substituted with one or more substituents each independently selected from the group comprising alkyl, alkenyl, cycloalkyl, cycloalkylalkyl, alkoxy, halogen, haloalkyl; wherein at least one of R^{2*} or R^{4*} is unsubstituted or substituted aryl, wherein R^{2*} is not in position 3 and/or R^{4*} is not on position 5 of each indenyl, wherein each R¹⁰ is independently hydrogen, alkyl, aryl, or alkenyl; and n*, q* are each independently an integer selected from 0, 1, 2, 3, or 4, wherein at least one of n* or q* is at least 1;
L^{1*} is SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl;
M^{1*} is a transition metal selected from the group comprising zirconium, titanium, hafnium, and vanadium; and preferably M^{1*} is zirconium; and
Q^{1*} and Q^{2*} are each independently selected from the group comprising hydrogen, halogen, hydroxyl, alkyl, alkenyl, —N(R¹¹)₂, —SR¹¹, alkoxy, cycloalkoxy, aralkoxy, cycloalkyl, aryl, aryloxy, alkylaryl, aralkyl, and heteroalkyl; wherein R¹¹ is hydrogen or alkyl or aryl.
27. The composition according to any one of statements 1-26, wherein the catalyst component B contains a SiR⁸R⁹, or —[CR⁸R⁹]ₕ— bridging group; preferably a SiR⁸R⁹ bridging group; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl, preferably alkyl; or R⁸ and R⁹ together with the atom to which they are attached form a cycloalkyl, cycloalkenyl or heterocyclyl.
28. The composition according to any one of statements 1-27, wherein catalyst component B comprises a bridged metallocene of formula (IIa),

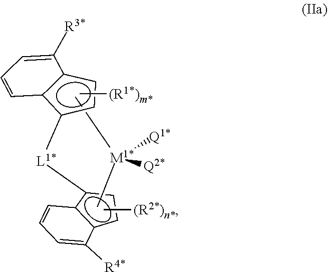

wherein R^{1*}, R^{2*}, R^{3*}, R^{4*}, L^{1*}, M^{1*}, Q^{1*}, Q^{2*}, m* and n* have the same meaning as that defined in any one of statements 26-27, preferably R^{3*} and R^{4*} are each independently C₆₋₁₀aryl which can be unsubstituted or substituted with one or more substituents each independently selected from the group comprising C₁₋₆alkyl, C₁₋₆alkoxy, halogen, haloC₁₋₆ alkyl.
29. The composition according to any one of statements 26-28, wherein
   R^{1*} is selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl; wherein each of said group can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl; wherein each R¹⁰ is independently hydrogen, C₁₋₂₀alkyl, or C₃₋₂₀alkenyl; and m* is an integer selected from 0, or 1, preferably m* is 1;
   R^{3*} is C₆₋₂₀aryl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl, preferably R^{3*} is phenyl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl;
   R^{2*} is selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl; wherein each of said group can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl; wherein each R¹⁰ is independently hydrogen, C₁₋₂₀alkyl, or C₃₋₂₀alkenyl; and n* is an integer selected from 0, or 1, preferably n* is 1;
   R^{4*} is C₆₋₂₀aryl which can be unsubstituted or substituted with one or more substituents each independently selected from the group comprising C₁₋₆alkyl, C₃₋₆alkenyl, C₃₋₆ cycloalkyl, C₃₋₆cycloalkylC₁₋₆alkyl, C₁₋₆-alkoxy, halogen, haloC₁₋₆alkyl, preferably R^{4*} is phenyl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl;
   L^{1*} is SiR⁸R⁹, or —[CR⁸R⁹]ₕ—, wherein h is an integer selected from 1, 2, or 3; each of R⁸, and R⁹ are independently selected from the group comprising hydrogen, C₁₋₂₀alkyl, C₃₋₂₀alkenyl, C₃₋₂₀ cycloalkyl, C₅₋₂₀cycloalkenyl, C₆₋₂₀cycloalkenylalkyl, C₆₋₁₀aryl, aminoC₁₋₆alkyl, and C₇-C₂₀arylalkyl; or R⁸ and R⁹ together with the atom to which they are attached form a C₃₋₂₀cycloalkyl, C₅₋₂₀cycloalkenyl or heterocyclyl; preferably L^{1*} is SiR⁸R⁹; each of R⁸, and R⁹ are independently selected from the group comprising hydrogen, C₁₋₂₀alkyl, C₃₋₂₀alkenyl, C₃₋₂₀ cycloalkyl, C₅₋₂₀cycloalkenyl, C₆₋₂₀cycloalkenylalkyl, C₆₋₁₀aryl, aminoC₁₋₆alkyl, and C₇-C₂₀arylalkyl; or R⁸ and R⁹ together with the atom to which they are attached form a C₃₋₂₀cycloalkyl, C₅₋₂₀cycloalkenyl or heterocyclyl; preferably each of R⁸, and R⁹ are independently C₁₋₆alkyl;
   M^{1*} is a transition metal selected from the group comprising zirconium, titanium, hafnium, and vanadium; and preferably M is zirconium; and
   Q^{1*} and Q^{2*} are each independently selected from the group consisting of hydrogen, halogen, C₁₋₂₀alkyl, —N(R¹¹)₂, C₁₋₂₀alkoxy, C₃₋₂₀cycloalkoxy, C₇₋₂₀aralkoxy, C₃₋₂₀cycloalkyl, C₆₋₂₀aryl, C₇₋₂₀alkylaryl, C₇₋₂₀aralkyl, and heteroC₁₋₂₀alkyl; wherein R¹¹ is hydrogen or C₁₋₂₀alkyl.
30. The composition according to any one of statements 26-29, wherein
   R^{1*} is selected from the group comprising C₁₋₁₀alkyl, C₃₋₁₀alkenyl, C₆₋₁₀aryl, C₁₋₁₀alkoxy, halogen, and heteroC₁₋₁₀alkyl; preferably R^{1*} is C₁₋₈alkyl;
   R^{3*} is C₆₋₁₀aryl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl, preferably R^{3*} is phenyl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl;
   m* is an integer selected from 0, or 1, preferably m* is 1;
   R^{2*} is selected from the group comprising C₁₋₁₀alkyl, C₂₋₁₀alkenyl, C₆₋₁₀aryl, C₁₋₁₀alkoxy, halogen, and heteroC₁₋₁₀alkyl; preferably R^{2*} is C₁₋₈alkyl;
   R^{4*} is C₆₋₁₀aryl which can be unsubstituted or substituted with one or more substituents each independently selected from the group comprising C₁₋₆alkyl, C₃₋₆alkenyl, C₃₋₆cycloalkyl, C₃₋₆cycloalkylC₁₋₆alkyl, C₁₋₆alkoxy, halogen, haloC₁₋₆alkyl, preferably R^{4*} is phenyl which can be unsubstituted or substituted with one or more substituents each independently selected from the group comprising C₁₋₅alkyl, C₃₋₆alkenyl, C₃₋₆cycloalkyl, C₃₋₆cycloalkylC₁₋₆alkyl, C₁₋₆alkoxy, halogen, haloC₁₋₆alkyl;
   n* is an integer selected from 0, or 1, preferably n* is 1;
   L^{1*} is SiR⁸R⁹, —[CR⁸R⁹]ₕ—; wherein h is an integer selected from 1, 2, or 3; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, C₆₋₁₀aryl, aminoC₁₋₆alkyl, and C₇-C₁₂arylalkyl; or R⁸ and R⁹ together with the atom to which they are attached form a C₃₋₈cycloalkyl, C₅₋₈cycloalkenyl or heterocyclyl; preferably L^{1*} is SiR⁸R⁹; preferably each of R⁸, and R⁹ are independently selected from hydrogen, or C₁₋₈alkyl;
   M^{1*} is a transition metal selected from the group comprising zirconium, titanium, hafnium, and vanadium; and preferably M is zirconium; and
   Q^{1*} and Q^{2*} are each independently selected from the group comprising hydrogen, halogen, C₁₋₈alkyl, —N(R¹¹)₂, C₁₋₈alkoxy, C₃₋₈cycloalkoxy, C₇₋₁₂aralkoxy, C₃₋₈cycloalkyl, C₆₋₁₀aryl, C₇₋₁₂ alkylaryl, C₇₋₁₂aralkyl, and heteroC₁₋₈alkyl; wherein R¹¹ is hydrogen or C₁₋₈alkyl.
31. The composition according to any one of statements 26-30, wherein
   R^{1*} is selected from the group comprising C₁₋₈alkyl, C₃₋₈alkenyl, C₃₋₈cycloalkyl, C₆₋₁₀aryl, and halogen; preferably R^{1*} is C₁₋₈alkyl;
   R^{3*} is C₆₋₁₀aryl which can be unsubstituted or substituted with one or more substituents each independently selected from the group comprising C₁₋₆alkyl, C₃₋₆alkenyl, C₁₋₆alkoxy, halogen, haloC₁₋₆alkyl, preferably R^{3*} is phenyl which can be unsubstituted or substituted with one or more substituents each independently selected from the group comprising C₁₋₆ alkyl, C₁₋₆alkoxy, halogen, haloC₁₋₆alkyl;
   m* is an integer selected from 0, or 1, preferably m* is 1;
   R^{2*} is selected from the group comprising C₁₋₈alkyl, C₃₋₈alkenyl, C₃₋₈cycloalkyl, C₆₋₁₀aryl, and halogen; preferably R^{2*} is C₁₋₈alkyl;
   R^{4*} is C₆₋₁₀aryl which can be unsubstituted or substituted with one or more substituents each independently selected from the group comprising C₁₋₆alkyl, C₃₋₆alkenyl, C₁₋₆alkoxy, halogen, haloC₁₋₆alkyl, preferably R^{4*} is phenyl which can be unsubstituted or substituted with one or more substituents each independently selected from the group comprising C₁₋₆ alkyl, C₁₋₆alkoxy, halogen, haloC₁₋₆alkyl;
   n* is an integer selected from 0, or 1, preferably n* is 1;
   L^{1*} is SiR⁸R⁹, or —[CR⁸R⁹]ₕ—; wherein h is an integer selected from 1, or 2; each of R⁸, and R⁹ are independently selected from the group comprising hydrogen, C₁₋₈alkyl, C₃₋₈alkenyl, C₃₋₈cycloalkyl; C₅₋₈cycloalkenyl, C₆₋₈cycloalkenylalkyl, and C₆₋₁₀aryl; preferably L^{1*} is SiR⁸R⁹; preferably each of R⁸, and R⁹ are independently selected from hydrogen, or C₁₋₈ alkyl;
   M^{1*} is a transition metal selected from zirconium, or hafnium; and preferably M is zirconium; and
   Q^{1*} and Q^{2*} are each independently selected from the group comprising hydrogen, halogen, C₁₋₈alkyl, —N(R¹¹)₂, C₆₋₁₀aryl, and C₇₋₁₂aralkyl; wherein R¹¹ is hydrogen or C₁₋₈alkyl, preferably Q^{1*} and Q^{2*} are each independently selected from the group comprising Cl, F, Br, I, methyl, benzyl, and phenyl.
32. The composition according to any one of statements 1-31, wherein catalyst component B comprises bridged metallocene of formula (IIb)

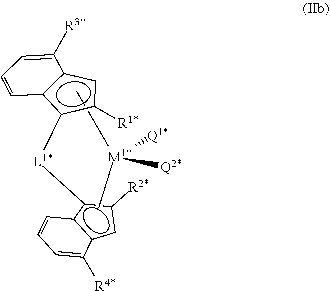

wherein R^{1*}, R^{2*}, R^{3*}, R^{4*}, L^{1*}, M^{1*}, Q^{1*}, Q^{2*}, have the same meaning as that defined in any one of statements 26-31, preferably R^{3*} and R^{4*} are each independently C₆₋₁₀aryl which can be unsubstituted or substituted with one or more substituents each independently selected from the group comprising C₁₋₆alkyl, C₁₋₆alkoxy, halogen, haloC₁₋₆alkyl.
33. The composition according to any one of statements 1-32, wherein catalyst component B comprises bridged metallocene of formula (IIc)

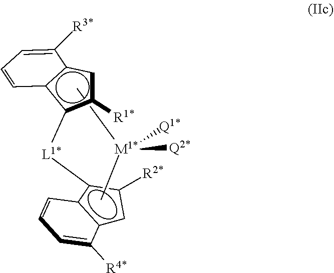

wherein R^{1*}, R^{2*}, R^{3*}, R^{4*}, L^{1*}, M^{1*}, Q^{1*}, Q^{2*}, have the same meaning as that defined in any one of statements 26-31, preferably R^{3*} and R^{4*} are each independently C₆₋₁₀aryl which can be unsubstituted or substituted with one or more substituents each independently selected from the group comprising C₁₋₆alkyl, C₁₋₆alkoxy, halogen, haloC₁₋₆alkyl.
34. The composition according to any one of statements 1-33, wherein catalyst component B comprises a bridged metallocene of formula (IId), or (IIe)

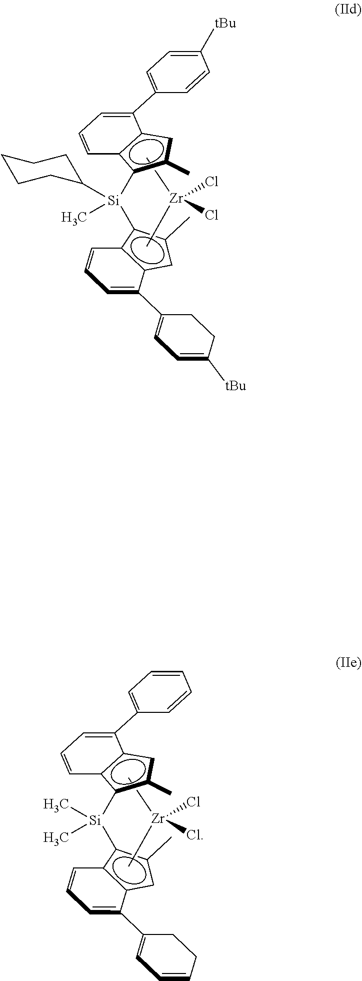

35. The composition according to any one of statements 1-34, wherein catalyst component B comprises the rac form of bridged metallocene of formula (II), (IIa), (IIb), (IIc), (IId) or (IIe).
36. An olefin polymerization process, the process comprising: contacting a catalyst composition according to any one of statements 1-35, with an olefin monomer, optionally hydrogen, and optionally one or more olefin comonomers; and polymerizing the monomer, and the optionally one or more olefin comonomers, in the presence of the at least one catalyst composition, and optional hydrogen, thereby obtaining a polyolefin.
37. The process according to statement 36, wherein the process is performed in the slurry phase or gas phase or liquid phase, preferably in the slurry phase.
38. The process according to any one of statements 36-37, wherein the process is conducted in one or more batch reactors, slurry reactors, gas-phase reactors, solution reactors, high pressure reactors, tubular reactors, autoclave reactors, or a combination thereof.
39. The process according to any one of statements 36-38, wherein the process is conducted in a single reaction zone.
40. The process according to any one of statements 36-39, wherein the olefin monomer is ethylene, and the olefin comonomer comprises propylene, 1-butene, 2-butene, 3-methyl-1-butene, isobutylene, 1-pentene, 2-pentene, 3-methyl-I-pentene, 4-methyl-1-pentene, 1-hexene, 2-hexene, 3-ethyl-1-hexene, 1-heptene, 2-heptene, 3-heptene, 1-octene, 1-decene, styrene, or a mixture thereof.
41. The process according to any one of statements 36-39, wherein the olefin monomer is propylene, and the olefin comonomer comprises ethylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or a mixture thereof.
42. The process according to any one of statements 36-40, wherein the olefin monomer is ethylene, and comprises contacting ethylene and optionally the olefin comonomer with the catalyst composition; and obtaining an ethylene polymer having a molecular weight distribution M_{w}/Mₙ ranging from 4.5 to 16.0, preferably from 5.0 to 15.0, preferably from 5.5 to 14.0, with M_{w} being the weight-average molecular weight and Mₙ being the number-average molecular weight.
43. The process according to any one of statements 36-40, 42, wherein the olefin monomer is ethylene, and comprises contacting ethylene and optionally the olefin comonomer with the catalyst composition; and obtaining an ethylene polymer having a molecular weight distribution M_{z}/M_{w} of at most 9.0, with M_{z} being the z average molecular weight, preferably at most 8.5, preferably at most 8.0, preferably at least 2.0, preferably at least 2.5.
44. The process according to any one of statements 36-40, 42-43, wherein the olefin monomer is ethylene, and comprises contacting ethylene and optionally the olefin comonomer with the catalyst composition; and obtaining an ethylene polymer having a total comonomer content, for example 1-hexene content, relative to the total weight of the ethylene polymer ranging from 0.0% by weight to 12.0% by weight, as determined by ¹³C NMR analysis, preferably from 0.0% by weight to 10.0% by weight, preferably from 0.0% by weight to 9.0% by weight.
45. The process according to any one of statements 36-40, 42-44, wherein the olefin monomer is ethylene, and comprises contacting ethylene and optionally the olefin comonomer with the catalyst composition; and obtaining an ethylene polymer having a melt index ranging from HL275 of 0.10 g/10 min to a melt index MI₂ of 15.0 g/10 min wherein MI₂ is determined according to ISO 1133:2005 Method B, condition D, at a temperature 190° C., and a 2.16 kg load using a die of 2.096 mm, and HL275 is determined according to ISO 1133:2005 Method B, condition G, at a temperature of 190° C. and under a load of 21.6 kg except that a die of 2.75 mm was used.
46. An olefin polymer at least partially catalyzed by at least one catalyst composition according to any one of statements 1-35 or produced by the process according to any one of statements 36-45.
47. The olefin polymer according to statement 46, wherein said olefin polymer is an ethylene polymer.
48. The olefin polymer according to statement 47, having a melt index ranging from HL275 of 0.10 g/10 min to a melt index MI₂ of 15.0 g/10 min wherein MI₂ is determined according to ISO 1133:2005 Method B, condition D, at a temperature 190° C., and a 2.16 kg load using a die of 2.096 mm, and HL275 is determined according to ISO 1133:2005 Method B, condition G, at a temperature of 190° C. and under a load of 21.6 kg except that a die of 2.75 mm was used.
49. The olefin polymer according to any one of statements 47-48, having a molecular weight distribution M_{w}/Mₙ ranging from 4.5 to 16.0, preferably from 5.0 to 15.0, preferably from 5.5 to 14.0, with M_{w} being the weight-average molecular weight and Mₙ being the number-average molecular weight.
50. The olefin polymer according to any one of statements 47-49, having a molecular weight distribution M_{z}/M_{w} of at most 9.0, with M_{z} being the z average molecular weight, preferably at most 8.5, preferably at most 8.0, preferably at least 2.0, preferably at least 2.5.
51. The olefin polymer according to any one of statements 47-50, wherein said polymer is a homopolymer.
52. The olefin polymer according to any one of statements 47-51, wherein said polymer is a copolymer of ethylene and a higher alpha-olefin co-monomer, preferably 1-hexene.
53. The olefin polymer according to any one of statements 47-52, having a total comonomer content, for example 1-hexene content, relative to the total weight of the ethylene polymer ranging from 0.0% by weight to 12.0% by weight, as determined by ¹³C NMR analysis, preferably from 0.0% by weight to 10.0% by weight, preferably from 0.0% by weight to 9.0% by weight.
54. The olefin polymer according to any one of statements 47-53, having a melt index ranging from HL275 of 0.10 g/10 min to a melt index MI₂ of 15.0 g/10 min wherein MI₂ is determined according to ISO 1133:2005 Method B, condition D, at a temperature 190° C., and a 2.16 kg load using a die of 2.096 mm, and HL275 is determined according to ISO 1133:2005 Method B, condition G, at a temperature of 190° C. and under a load of 21.6 kg except that a die of 2.75 mm was used;
   a molecular weight distribution M_{w}/Mₙ ranging from 4.5 to 16.0, preferably from 5.0 to 15.0, preferably from 5.5 to 14.0, with M_{w} being the weight-average molecular weight and Mₙ being the number-average molecular weight;
   a molecular weight distribution M_{z}/M_{w} of at most 9.0, with M_{z} being the z average molecular weight, preferably at most 8.5, preferably at most 8.0, preferably at least 2.0, preferably at least 2.5; and
   a total comonomer content, for example 1-hexene content, relative to the total weight of the ethylene polymer ranging from 0.0% by weight to 12.0% by weight, as determined by ¹³C NMR analysis, preferably from 0.0% by weight to 10.0% by weight, preferably from 0.0% by weight to 9.0% by weight.
55. The olefin polymer according to any one of statements 46-54, catalyzed using a composition according to any one of statements 1-35.
56. An article comprising the polymer according to any one of statements 45-55, or comprising the polymer obtained using a process according to any one of statements 36-45.
57. The article according to statement 56, wherein the article is selected from the group comprising film products, caps and closures, rotomoulding, grass yarn, pressure/temperature resistant pipes etc.
58. Use of a polymer according to any one of statements 46-55, or obtained using a process according to any one of statements 36-45, in film applications, caps and closures applications, rotomoulding applications, grass yarn applications, pressure/temperature resistant pipes applications etc.

The present invention provides a catalyst composition comprising catalyst component A comprising the meso form of a bridged metallocene compound with two indenyl groups, each indenyl being independently substituted with one or more substituents, wherein at least one of the substituents is on position 3 and/or 5 of each indenyl, and wherein at least one of the substituents is an unsubstituted or substituted aryl or heteroaryl, preferably wherein the meso/rac ratio of the meso form of the bridged metallocene compound of catalyst component A is 95:5 or greater, as determined using ¹H NMR; preferably at least one of the substituents is aryl; preferably each indenyl has one substituent on position 3, preferably each indenyl has one substituent on position 5, yet more preferably each indenyl has one substituent on position 3 and one substituent on position 5 of each indenyl, preferably the aryl or heteroaryl substituent is on 3-position of each indenyl;
catalyst component B comprising a bridged metallocene compound with two indenyl groups, each indenyl being independently substituted with one or more substituents, wherein at least one of the substituents is an unsubstituted or substituted aryl or heteroaryl; and wherein the unsubstituted or substituted aryl or heteroaryl substituent is not on position 3 and/or 5 of the indenyl, preferably not on position 3 and 5 of each indenyl; preferably each indenyl has one or more substituents on positions 2 and/or 4 of each indenyl, preferably each indenyl has one substituent on position 2, preferably each indenyl has one substituent on position 4, yet more preferably each indenyl has one substituent on position 2 and one substituent on position 4 of each indenyl, preferably the unsubstituted or substituted aryl or heteroaryl is on position 4 of each indenyl; and
an optional activator; an optional support; and an optional co-catalyst.

For nomenclature purposes, the following numbering scheme is used for indenyl. It should be noted that indenyl can be considered a cyclopentadienyl with a fused benzene ring. The structure below is drawn and named as an anion:

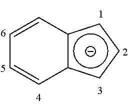

indenyl.

As used herein, the term “catalyst” refers to a substance that causes a change in the rate of a reaction. In the present invention, it is especially applicable to catalysts suitable for a polymerization, preferably for the polymerization of olefins to polyolefins.

As used herein, the term “meso” or “meso form” means that the bridge metallocene of component A has plane of symmetry containing the metal center, M.

The term “metallocene catalyst” is used herein to describe any transition metal complexes comprising metal atoms bonded to one or more ligands. The metallocene catalysts are compounds of Group IV transition metals of the Periodic Table such as titanium, zirconium, hafnium, etc., and have a coordinated structure with a metal compound and ligands composed of one or two groups of cyclopentadienyl, indenyl, tetrahydroindenyl, fluorenyl or their derivatives. Metallocenes comprise a single metal site, which allows for more control of branching and molecular weight distribution of the polymer. Monomers are inserted between the metal and the growing chain of polymer.

In one embodiment, for catalyst A, the bridged metallocene catalyst can be represented by the meso form of compound of formula (III), and for catalyst B by compound of formula (IV): wherein

L¹(Ar¹)₂M¹Q¹Q² (III),

L^{1*}(Ar^{1*})₂M^{1*}Q^{1*}Q^{2*} (IV),
each Ar¹ is independently indenyl, optionally substituted with one or more substituents each independently selected from the group comprising alkyl, alkenyl, cycloalkyl, aryl, alkoxy, alkylaryl, arylalkyl, halogen, Si(R¹⁰)₃, and heteroalkyl; wherein each R¹⁰ is independently hydrogen, alkyl, or alkenyl. Each indenyl is substituted in the same way or differently from one another at one or more positions of either of the fused rings. Each substituent can be independently chosen. Preferably, each Ar¹ is indenyl, each indenyl being independently substituted with one or more substituents, wherein at least one of the substituents is an aryl or heteroaryl; preferably wherein at least one of the substituents is on position 3 and/or 5 of each indenyl, preferably wherein the aryl or heteroaryl is on the 3-position of each indenyl, wherein Ar¹ can be further substituted with one or more substituents each independently selected from the group comprising alkyl, alkenyl, cycloalkyl, aryl, alkoxy, alkylaryl, arylalkyl, halogen, Si(R¹⁰)₃, and heteroalkyl; wherein each R¹⁰ is independently hydrogen, alkyl, or alkenyl;
each Ar^{1*} is independently indenyl, each indenyl being independently substituted with one or more substituents, wherein at least one of the substituents is an unsubstituted or substituted aryl or heteroaryl; preferably wherein the unsubstituted or unsubstituted or substituted aryl or heteroaryl substituent is not on the position 3 and/or 5 of the indenyl, preferably wherein the unsubstituted or substituted aryl or heteroaryl is on the 4-position of each indenyl; preferably, one or more substituents of indenyl is independently selected from the group comprising alkyl, alkenyl, cycloalkyl, aryl, alkoxy, alkylaryl, arylalkyl, halogen, Si(R¹⁰)₃, and heteroalkyl; wherein each of said group can be unsubstituted or substituted with one or more substituents each independently selected from the group comprising alkyl, alkenyl, cycloalkyl, cycloalkylalkyl, alkoxy, halogen, haloalkyl; wherein each R¹⁰ is independently hydrogen, alkyl, or alkenyl. Each indenyl is substituted in the same way or differently from one another at one or more positions of either of the fused rings. Each substituent can be independently chosen. Preferably, each Ar^{1*} is indenyl, each indenyl being independently substituted with one or more substituents, wherein at least one of the substituents is an unsubstituted or substituted aryl or heteroaryl; preferably wherein the unsubstituted or substituted aryl or heteroaryl substituent is on the 4-position of each indenyl, wherein Ar^{1*} can be further substituted with one or more substituents each independently selected from the group comprising alkyl, alkenyl, cycloalkyl, aryl, alkoxy, alkylaryl, arylalkyl, halogen, Si(R¹⁰)₃, and heteroalkyl; wherein each R¹⁰ is independently hydrogen, alkyl, or alkenyl;
each of M¹ and M^{1*} is a transition metal selected from the group comprising zirconium, hafnium, titanium, and vanadium; and preferably each of M¹ and M² is zirconium;
Q¹ and Q² are each independently selected from the group comprising halogen, alkyl, —N(R¹¹)₂, alkoxy, cycloalkoxy, aralkoxy, cycloalkyl, aryl, alkylaryl, aralkyl, and heteroalkyl; wherein R¹¹ is hydrogen or alkyl;
Q^{1*} and Q^{2*} are each independently selected from the group comprising hydrogen, halogen, alkyl, —N(R¹¹)₂, alkoxy, cycloalkoxy, aralkoxy, cycloalkyl, aryl, alkylaryl, aralkyl, and heteroalkyl; wherein R¹¹ is hydrogen or alkyl;
L¹ is a divalent group or moiety bridging the two Ar¹ groups, preferably selected from SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl; preferably L¹ is SiR⁸R⁹;
L^{1*} is a divalent group or moiety bridging the two Ar^{1*} groups, preferably selected from SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl; preferably L^{1*} is SiR⁸R⁹;

In some embodiments, each Ar¹ is indenyl, each indenyl being independently substituted with one or more substituents, wherein at least one of the substituents is an aryl or heteroaryl; preferably wherein at least one of the substituents is on position 3 and/or 5 of each indenyl, preferably wherein the aryl or heteroaryl substituent is on the 3-position of each indenyl; each indenyl being further optionally substituted with one or more substituents each independently selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl; wherein each R¹⁰ is independently hydrogen, C₁₋₂₀alkyl, or C₃₋₂₀alkenyl.

Preferably each Ar¹ is indenyl, each indenyl being independently substituted with one or more substituents, wherein at least one of the substituents is an C₆₋₁₀aryl; preferably wherein the C₆₋₁₀aryl substituent is on the 3-position of each indenyl; each indenyl being further optionally substituted with one or more substituents each independently selected from the group comprising C₁₋₈alkyl, C₃₋₈alkenyl, C₃₋₈cycloalkyl, C₅₋₈cycloalkenyl, C₆₋₈cycloalkenylalkyl, C₆₋₁₀aryl, C₁₋₈alkoxy, C₇₋₁₂alkylaryl, C₇₋₁₂arylalkyl, halogen, Si(R¹⁰)₃, and heteroC₁₋₈alkyl; wherein each R¹⁰ is independently hydrogen, C₁₋₈alkyl, or C₃₋₈alkenyl. Preferably each Ar¹ is indenyl, each indenyl being independently substituted with one or more substituents, wherein at least one of the substituents is an C₆₋₁₀aryl; preferably wherein the C₆₋₁₀aryl substituent is on the 3-position of each indenyl; each indenyl being further optionally substituted with one or more substituents each independently selected from the group comprising C₁₋₈alkyl, C₃₋₈alkenyl, C₃₋₈cycloalkyl, C₆₋₁₀aryl, and halogen.

In some embodiments, each Ar^{1*} is indenyl, each indenyl being independently substituted with one or more substituents, wherein at least one of the substituents is an aryl or heteroaryl; preferably wherein the aryl or heteroaryl substituent is on the 4-position of each indenyl; each indenyl being further optionally substituted with one or more substituents each independently selected from the group comprising C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₂₀aryl, C₁₋₂₀alkoxy, C₇₋₂₀alkylaryl, C₇₋₂₀arylalkyl, halogen, Si(R¹⁰)₃, and heteroC₁₋₁₂alkyl (said further substituent being preferably on position 2 of each indenyl); wherein each R¹⁰ is independently hydrogen, C₁₋₂₀alkyl, or C₃₋₂₀alkenyl.

Preferably each Ar^{1*} is indenyl, each indenyl being independently substituted with one or more substituents, wherein at least one of the substituents is an unsubstituted or substituted C₆₋₁₀aryl; wherein the unsubstituted or substituted C₆₋₁₀aryl is on the 4-position on each indenyl; each indenyl being further substituted on position 2 with one or more substituents each independently selected from the group comprising C₁₋₈alkyl, C₃₋₈alkenyl, C₃₋₈cycloalkyl, C₅₋₈ cycloalkenyl, C₆₋₈cycloalkenylalkyl, C₆₋₁₀aryl, C₁₋₈alkoxy, C₇₋₁₂alkylaryl, C₇₋₁₂arylalkyl, halogen, Si(R¹⁰)₃, and heteroC₁₋₈alkyl; wherein each R¹⁰ is independently hydrogen, C₁₋₈alkyl, or C₃₋₈alkenyl.

Preferably each Ar^{1*} is indenyl, each indenyl being independently substituted with one or more substituents, wherein at least one of the substituents is an unsubstituted or substituted C₆₋₁₀aryl; preferably wherein the unsubstituted or substituted C₆₋₁₀aryl is on the 4-position on each indenyl; each indenyl being further optionally substituted on position 2 with a substituent independently selected from the group comprising C₁₋₈alkyl, C₃₋₈alkenyl, C₃₋₈cycloalkyl, C₆₋₁₀aryl, and halogen.

In some embodiments, L¹ is —[CR⁸R⁹]ₕ—, SiR⁸R⁹, GeR⁸R⁹, or BR⁸; wherein h is an integer selected from 1, 2, or 3; each of R⁸, and R⁹ are independently selected from the group comprising hydrogen, C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₁₀aryl, and C₇-C₂₀arylalkyl; or R⁸ and R⁹ together with the atom to which they are attached form a C₃₋₂₀cycloalkyl, C₅₋₂₀cycloalkenyl or heterocyclyl. Preferably L¹ is —[CR⁸R⁹]ₕ—, SiR⁸R⁹, GeR⁸R⁹, or BR⁸; wherein h is an integer selected from 1, 2, or 3; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, C₆₋₁₀aryl, and C₇-C₁₂arylalkyl; or R⁸ and R⁹ together with the atom to which they are attached form a C₃₋₈cycloalkyl, C₅₋₈cycloalkenyl or heterocyclyl. Preferably, L¹ is —[CR⁸R⁹]ₕ—, or SiR⁸R⁹; wherein h is an integer selected from 1, or 2; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, and C₆₋₁₀aryl. Preferably, L¹ is SiR⁸R⁹; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, and C₆₋₁₀aryl; preferably C₁₋₈alkyl.

In some embodiments, Q¹ and Q² are each independently selected from the group comprising halogen, C₁₋₂₀alkyl, —N(R¹¹)₂, C₁₋₂₀alkoxy, C₃₋₂₀cycloalkoxy, C₇₋₂₀aralkoxy, C₃₋₂₀cycloalkyl, C₆₋₂₀aryl, C₇₋₂₀alkylaryl, C₇₋₂₀aralkyl, and heteroC₁₋₂₀alkyl; wherein R¹¹ is hydrogen or C₁₋₂₀alkyl. Preferably Q¹ and Q² are each independently selected from the group comprising halogen, C₁₋₈alkyl, —N(R¹¹)₂, C₁₋₈alkoxy, C₃₋₈cycloalkoxy, C₇₋₁₂aralkoxy, C₃₋₈cycloalkyl, C₆₋₁₀aryl, C₇₋₁₂ alkylaryl, C₇₋₁₂aralkyl, and heteroC₁₋₈alkyl; wherein R¹¹ is hydrogen or C₁₋₈alkyl. Preferably, Q¹ and Q² are each independently selected from the group comprising halogen, C₁₋₈alkyl, —N(R¹¹)₂, C₆₋₁₀aryl, and C₇₋₁₂aralkyl; wherein R¹¹ is hydrogen or C₁₋₈alkyl, preferably Q¹ and Q² are each independently selected from the group comprising Cl, F, Br, I, methyl, benzyl, and phenyl.

In some embodiments, L^{1*} is —[CR⁸R⁹]ₕ—, SiR⁸R⁹, GeR⁸R⁹, or BR⁸; wherein h is an integer selected from 1, 2, or 3; each of R⁸, and R⁹ are independently selected from the group comprising hydrogen, C₁₋₂₀alkyl, C₃₋₂₀alkenyl, C₃₋₂₀cycloalkyl, C₅₋₂₀cycloalkenyl, C₆₋₂₀cycloalkenylalkyl, C₆₋₁₀aryl, and C₇-C₂₀arylalkyl; or R⁸ and R⁹ together with the atom to which they are attached form a C₃₋₂₀cycloalkyl, C₅₋₂₀cycloalkenyl or heterocyclyl. Preferably L^{1*} is —[CR⁸R⁹]ₕ—, SiR⁸R⁹, GeR⁸R⁹, or BR⁸; wherein h is an integer selected from 1, 2, or 3; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, C₆₋₁₀aryl, and C₇-C₁₂arylalkyl; or R⁸ and R⁹ together with the atom to which they are attached form a C₃₋₈cycloalkyl, C₅₋₈cycloalkenyl or heterocyclyl. Preferably, L^{1*} is —[CR⁸R⁹]ₕ—, or SiR⁸R⁹; wherein h is an integer selected from 1, or 2; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, and C₆₋₁₀aryl. Preferably, L^{1*} is SiR⁸R⁹; each of R⁸, and R⁹ are independently selected from the group comprising hydrogen, C₁₋₈alkyl, C₃₋₈alkenyl, C₃₋₈cycloalkyl, C₅₋₈cycloalkenyl, C₆₋₈cycloalkenylalkyl, and C₆₋₁₀aryl; preferably C₁₋₈alkyl.

In some embodiments, Q^{1*} and Q^{2*} are each independently selected from the group comprising hydrogen, halogen, C₁₋₂₀alkyl, —N(R¹¹)₂, C₁₋₂₀alkoxy, C₃₋₂₀cycloalkoxy, C₇₋₂₀aralkoxy, C₃₋₂₀cycloalkyl, C₆₋₂₀aryl, C₇₋₂₀alkylaryl, C₇₋₂₀aralkyl, and heteroC₁₋₂₀alkyl; wherein R¹¹ is hydrogen or C₁₋₂₀alkyl. Preferably Q^{1*} and Q^{2*} are each independently selected from the group comprising halogen, C₁₋₈alkyl, —N(R¹¹)₂, C₁₋₈alkoxy, C₃₋₈cycloalkoxy, C₇₋₁₂aralkoxy, C₃₋₈cycloalkyl, C₆₋₁₀aryl, C₇₋₁₂alkylaryl, C₇₋₁₂aralkyl, and heteroC₁₋₈alkyl; wherein R¹¹ is hydrogen or C₁₋₈alkyl. Preferably, Q^{1*} and Q^{2*} are each independently selected from the group comprising halogen, C₁₋₈alkyl, —N(R¹¹)₂, C₆₋₁₀aryl, and C₇₋₁₂aralkyl; wherein R¹¹ is hydrogen or C₁₋₈alkyl, preferably Q^{1*} and Q^{2*} are each independently selected from the group comprising Cl, F, Br, I, methyl, benzyl, and phenyl.

In some preferred embodiments, catalyst component A comprises the meso form of a bridged metallocene catalyst of formula (I); wherein

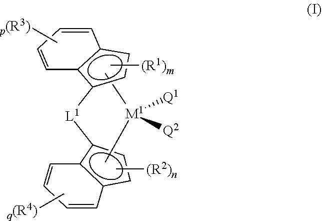

wherein each of R¹, R² R³ and R⁴, m, n, p, q, L¹, M¹, Q¹ and Q² have the same meaning as that defined herein above and in the statements.

In a preferred embodiment, the meso/rac ratio of the meso form of the bridged metallocene compound of catalyst component A is 95:5 or greater.

A non-limiting example of catalyst A is the meso form of the catalyst shown below

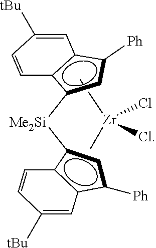

In some preferred embodiments, catalyst component B comprises a bridged metallocene catalyst of formula (II),

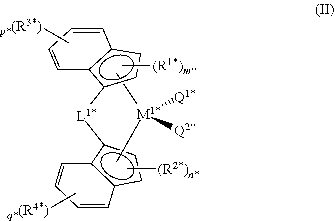

wherein each of R^{1*}, R^{2*}, R^{3*} and R^{4*}, m*, n*, p*, q*, L^{1*}, M^{1*}, Q^{1*} and Q^{2*} have the same meaning as that defined herein above and in the statements.

In some preferred embodiments, catalyst component B comprises a bridged metallocene catalyst of formula (IIb) or (IIc)

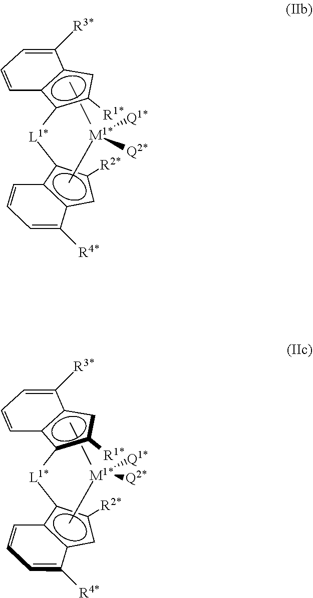

wherein R^{1*}, R^{2*}, R^{3*}, R^{4*}, L^{1*}, M^{1*}, Q^{1*}, Q^{2*}, have the same meaning as that defined herein above and in the statements.

### Non-Limiting Examples of Catalyst B are Shown Below

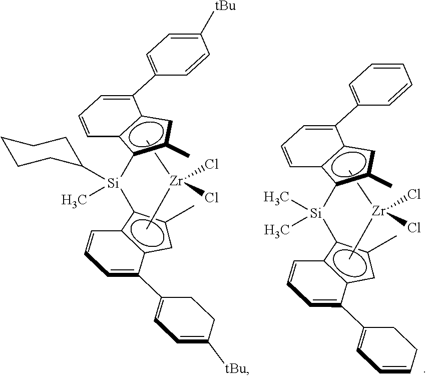

The catalyst components A and B herein are preferably provided on a solid support, preferably both catalysts are provided on a single solid support, thereby forming a dual catalyst system.

The support can be an inert organic or inorganic solid, which is chemically unreactive with any of the components of the conventional bridged metallocene catalyst. Suitable support materials for the supported catalyst include solid inorganic oxides, such as silica, alumina, magnesium oxide, titanium oxide, thorium oxide, as well as mixed oxides of silica and one or more Group 2 or 13 metal oxides, such as silica-magnesia and silica-alumina mixed oxides. Silica, alumina, and mixed oxides of silica and one or more Group 2 or 13 metal oxides are preferred support materials. Preferred examples of such mixed oxides are the silica-aluminas. For example the solid oxide comprises titanated silica, silica, alumina, silica-alumina, silica-coated alumina, aluminum phosphate, aluminophosphate, heteropolytungstate, titania, zirconia, magnesia, boria, zinc oxide, a mixed oxide thereof, or any mixture thereof, preferably silica, titanated silica, silica treated with fluoride, silica-alumina, alumina treated with fluoride, sulfated alumina, silica-alumina treated with fluoride, sulfated silica-alumina, silica-coated alumina, silica treated with fluoride, sulfated silica-coated alumina, or any combination thereof. Most preferred is a titanated silica, or a silica compound. In a preferred embodiment, the bridged metallocene catalysts are provided on a solid support, preferably a titanated silica, or a silica support. The silica may be in granular, agglomerated, fumed or other form.

In some embodiments, the support of catalyst components A and B is a porous support, and preferably a porous titanated silica, or silica support having a surface area comprised between 200 and 900 m²/g. In another embodiment, the support of the polymerization catalyst is a porous support, and preferably a porous titanated silica, or silica support having an average pore volume comprised between 0.5 and 4 mL/g. In yet another embodiment, the support of the polymerization catalyst is a porous support, and preferably a porous titanated silica, or silica support having an average pore diameter comprised between 50 and 300 Å, and preferably between 75 and 220 Å.

In some embodiments, the support has a D50 of at most 150 μm, preferably of at most 100 μm, preferably of at most 75 μm, preferably of at most 50 μm, preferably of at most 40 μm, preferably of at most 30 μm. The D50 is defined as the particle size for which fifty percent by weight of the particles has a size lower than the D50. The measurement of the particle size can be made according to the International Standard ISO 13320:2009 (“Particle size analysis-Laser diffraction methods”). For example, the D50 can be measured by sieving, by BET surface measurement, or by laser diffraction analysis. For example, Malvern Instruments' laser diffraction systems may advantageously be used. The particle size may be measured by laser diffraction analysis on a Malvern type analyzer. The particle size may be measured by laser diffraction analysis on a Malvern type analyzer after having put the supported catalyst in suspension in cyclohexane. Suitable Malvern systems include the Malvern 2000, Malvern MasterSizer (such as Mastersizer S), Malvern 2600 and Malvern 3600 series. Such instruments together with their operating manual meet or even exceed the requirements set-out within the ISO 13320 Standard. The Malvern MasterSizer (such as Mastersizer S) may also be useful as it can more accurately measure the D50 towards the lower end of the range e.g., for average particle sizes of less 8 μm, by applying the theory of Mie, using appropriate optical means.

Preferably, catalyst components A and B are activated by an activator. The activator can be any activator known for this purpose such as an aluminum-containing activator, a boron-containing activator, or a fluorinated activator. The aluminum-containing activator may comprise an alumoxane, an alkyl aluminum, a Lewis acid and/or a fluorinated catalytic support.

In some embodiments, alumoxane is used as an activator for catalyst components A and B. The alumoxane can be used in conjunction with a catalyst in order to improve the activity of the catalyst during the polymerization reaction.

As used herein, the term “alumoxane” and “aluminoxane” are used interchangeably, and refer to a substance, which is capable of activating the bridged metallocene catalyst. In some embodiments, alumoxanes comprise oligomeric linear and/or cyclic alkyl alumoxanes. In a further embodiment, the alumoxane has formula (V) or (VI)
R^{a}—(Al(R^{a})—O)ₓ—AlR^{a}₂ (V) for oligomeric, linear alumoxanes; or
(—Al(R^{a})—O—)_{y} (VI) for oligomeric, cyclic alumoxanes
wherein x is 1-40, and preferably 10-20;
wherein y is 3-40, and preferably 3-20; and
wherein each R^{a} is independently selected from a C₁₋₈alkyl, and preferably is methyl. In a preferred embodiment, the alumoxane is methylalumoxane (MAO).

The catalyst composition may comprise a co-catalyst. One or more aluminumalkyl represented by the formula AlR^{b}ₓ can be used as additional co-catalyst, wherein each R^{b} is the same or different and is selected from halogens or from alkoxy or alkyl groups having from 1 to 12 carbon atoms and x is from 1 to 3. Non-limiting examples are Tri-Ethyl Aluminum (TEAL), Tri-Iso-Butyl Aluminum (TIBAL), Tri-Methyl Aluminum (TMA), and Methyl-Methyl-Ethyl Aluminum (MMEAL). Especially suitable are trialkylaluminums, the most preferred being triisobutylaluminum (TIBAL) and triethylaluminum (TEAL).

The catalyst composition can be particularly useful in a process for the preparation of a polymer comprising contacting at least one monomer with at least one catalyst composition. Preferably, said polymer is a polyolefin, preferably said monomer is an alpha-olefin.

The catalyst composition of the present invention is therefore particularly suitable for being used in the preparation of a polyolefin. The present invention also relates to the use of a catalyst composition in olefin polymerization.

The present invention also encompasses an olefin polymerization process, the process comprising: contacting a catalyst composition according to the invention, with an olefin monomer, optionally hydrogen, and optionally one or more olefin comonomers; and polymerizing the monomer, and the optionally one or more olefin comonomers, in the presence of the at least one catalyst composition, and optional hydrogen, thereby obtaining a polyolefin.

The term “olefin” refers herein to molecules composed of carbon and hydrogen, containing at least one carbon-carbon double bond. Olefins containing one carbon-carbon double bond are denoted herein as mono-unsaturated hydrocarbons and have the chemical formula CₙH₂ₙ, where n equals at least two. “Alpha-olefins”, “α-olefins”, “1-alkenes” or “terminal olefins” are used as synonyms herein and denote olefins or alkenes having a double bond at the primary or alpha (a) position.

Throughout the present application the terms “olefin polymer”, “polyolefin” and “polyolefin polymer” may be used synonymously.

Suitable polymerization includes but is not limited to homopolymerization of an alpha-olefin, or copolymerization of the alpha-olefin and at least one other alpha-olefin comonomer.

As used herein, the term “comonomer” refers to olefin comonomers which are suitable for being polymerized with alpha-olefin monomer. The comonomer if present is different from the olefin monomer and chosen such that it is suited for copolymerization with the olefin monomer.

Comonomers may comprise but are not limited to aliphatic C₂-C₂₀ alpha-olefins. Examples of suitable aliphatic C₃-C₂₀ alpha-olefins include ethylene, propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene. Further examples of suitable comonomers are vinyl acetate (H₃C—C(═O)O—CH═CH₂) or vinyl alcohol (“HO—CH═CH₂”). Examples of olefin copolymers suited which can be prepared can be random copolymers of propylene and ethylene, random copolymers of propylene and 1-butene, heterophasic copolymers of propylene and ethylene, ethylene-butene copolymers, ethylene-hexene copolymers, ethylene-octene copolymers, copolymers of ethylene and vinyl acetate (EVA), copolymers of ethylene and vinyl alcohol (EVOH).

In some embodiments, the olefin monomer is ethylene, and the olefin comonomer comprises propylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or a mixture thereof.

In some embodiments, the olefin monomer is propylene, and the olefin comonomer comprises ethylene, 1-butene, 2-butene, 3-methyl-1-butene, isobutylene, 1-pentene, 2-pentene, 3-methyl-1-pentene, 4-methyl-1-pentene, 1-hexene, 2-hexene, 3-ethyl-1-hexene, 1-heptene, 2-heptene, 3-heptene, 1-octene, 1-decene, styrene, or a mixture thereof.

The polyolefin can be prepared out in bulk, gas, solution and/or slurry phase. The process can be conducted in one or more batch reactors, slurry reactors, gas-phase reactors, solution reactors, high pressure reactors, tubular reactors, autoclave reactors, or a combination thereof.

The term “slurry” or “polymerization slurry” or “polymer slurry”, as used herein refers to substantially a multi-phase composition including at least polymer solids and a liquid phase, the liquid phase being the continuous phase. The solids may include the catalyst and polymerized monomer.

In some embodiments, the liquid phase comprises a diluent. As used herein, the term “diluent” refers to any organic diluent, which does not dissolve the synthesized polyolefin. As used herein, the term “diluent” refers to diluents in a liquid state, liquid at room temperature and preferably liquid under the pressure conditions in the loop reactor. Suitable diluents comprise but are not limited to hydrocarbon diluents such as aliphatic, cycloaliphatic and aromatic hydrocarbon solvents, or halogenated versions of such solvents. Preferred solvents are C₁₂ or lower, straight chain or branched chain, saturated hydrocarbons, C₅ to C₉ saturated alicyclic or aromatic hydrocarbons or C₂ to C₆ halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane, preferably isobutane or hexane.

The polymerization can also be performed in gas phase, under gas phase conditions. The term “gas phase conditions” as used herein refers to temperatures and pressures suitable for polymerizing one or more gaseous phase olefins to produce polymer therefrom.

The polymerization steps can be performed over a wide temperature range. In certain embodiments, the polymerization steps may be performed at a temperature from 20° C. to 125° C., preferably from 60° C. to 110° C., more preferably from 75° C. to 100° C. and most preferably from 78° C. to 98° C. Preferably, the temperature range may be within the range from 75° C. to 100° C. and most preferably from 78° C. to 98° C. Said temperature may fall under the more general term of polymerization conditions.

In certain embodiments, in slurry conditions, the polymerization steps may be performed at a pressure from about 20 bar to about 100 bar, preferably from about 30 bar to about 50 bar, and more preferably from about 37 bar to about 45 bar. Said pressure may fall under the more general term of polymerization conditions.

The term “polyolefin resin” or “polyolefin” as used herein refers to the polyolefin fluff or powder that is extruded, and/or melted, and/or pelleted and can be prepared through compounding and homogenizing of the polyolefin resin as taught herein, for instance, with mixing and/or extruder equipment.

The term “fluff” or “powder” as used herein refers to the polyolefin material with the solid catalyst particle at the core of each grain and is defined as the polymer material after it exits the polymerization reactor (or final polymerization reactor in the case of multiple reactors connected in series). The term “pellets” refers to the polyolefin fluff that has been pelletized, for example through melt extrusion. As used herein, the terms “extrusion” or “extrusion process”, “pelletization” or “pelletizing” are used herein as synonyms and refer to the process of transforming polyolefin resin into a “polyolefin product” or into “pellets” after pelletizing. The process of pelletization preferably comprises several devices connected in series, including one or more rotating screws in an extruder, a die, and means for cutting the extruded filaments into pellets.

In an embodiment, the olefin polymer is a homopolymer. The term “homopolymer” as used herein is intended to encompass polymers which consist essentially of repeat units deriving from the monomer. Homopolymers may, for example, comprise at least 99.8% preferably 99.9% by weight of repeats units derived from the monomer, as determined for example by ¹³C NMR spectrometry.

In another embodiment, the polyethylene resin is a copolymer. The term “copolymer” as used herein is intended to encompass polymers which consist essentially of repeat units deriving from the monomer and at least one other C₃-C₂₀ alpha-olefin co-monomer, preferably wherein the co-monomer is 1-hexene.

As used herein, the term “co-monomer” refers to olefin co-monomers which are suitable for being polymerized with alpha-olefin monomer. Co-monomers may comprise but are not limited to aliphatic C₃-C₂₀ alpha-olefins, preferably C₃-C₁₂ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicosene. In some preferred embodiments, said co-monomer is 1-hexene.

In some embodiments, the olefin polymer is an ethylene polymer. In some embodiments, said ethylene polymer is a copolymer of ethylene and a higher alpha-olefin co-monomer, preferably 1-hexene, wherein the total co-monomer content, preferably 1-hexene (wt. % C6-) relative to the total weight of the ethylene polymer is at least 0.5% by weight, preferably at least 1.0% by weight, preferably at least 1.5% by weight, preferably at least 2.0% by weight, preferably at least 2.5% by weight, preferably at least 3.0% by weight, as determined by ¹³C NMR analysis. In some embodiments, said ethylene polymer is a copolymer of ethylene and a higher alpha-olefin co-monomer, preferably 1-hexene, wherein the total co-monomer content, preferably 1-hexene (wt. % C6) relative to the total weight of the polyethylene is at most 12.0% by weight, preferably at most 10.0% by weight, preferably at most 9.0% by weight, as determined by ¹³C NMR analysis.

Ethylene copolymers described herein can, in some embodiments, have a non-conventional (reverse or inverse) co-monomer distribution, i.e., the higher molecular weight portions of the polymer have higher co-monomer incorporation than the lower molecular weight portions. Preferably, there is an increasing co-monomer incorporation with increasing molecular weight, as shown by the ratio of the areas of IR signals (A_{CH3}/A_{CH2}) from IR5-MCT detector as function of log M.

As used herein, the term “monomodal ethylene polymer” or “ethylene polymer with a monomodal molecular weight distribution” refers to polyethylene having one maximum in their molecular weight distribution curve, which is also defined as a unimodal distribution curve. As used herein, the term “polyethylene with a bimodal molecular weight distribution” or “bimodal polyethylene” it is meant, polyethylene having a distribution curve being the sum of two unimodal molecular weight distribution curves, and refers to a polyethylene product having two distinct but possibly overlapping populations of polyethylene macromolecules each having different weight average molecular weights. By the term “polyethylenes with a multimodal molecular weight distribution” or “multimodal polyethylenes” it is meant polyethylenes with a distribution curve being the sum of at least two, preferably more than two unimodal distribution curves, and refers to a polyethylene product having two or more distinct but possibly overlapping populations of polyethylene macromolecules each having different weight average molecular weights. The multimodal polyethylene can have an “apparent monomodal” molecular weight distribution, which is a molecular weight distribution curve with a single peak and no shoulder. Nevertheless, the polyethylene will still be multimodal if it comprises two distinct populations of polyethylene macromolecules each having a different weight average molecular weight, as defined above, for example when the two distinct populations were prepared in different reactors and/or under different conditions and/or with different catalysts.

The present invention also encompasses a polyethylene composition comprising the ethylene polymer of the invention and one or more additives.

The additives can be for example antioxidants, UV stabilizers, pigments, processing aids, acid scavengers, lubricants, antistatic agents, fillers, nucleating agents, or clarifying agents, or combination thereof. An overview of useful additives is given in Plastics Additives Handbook, ed. H. Zweifel, 5^{th} edition, Hanser Publishers. These additives may be present in quantities generally between 0.01 and 10 weight % based on the weight of the polyethylene composition.

After the ethylene polymer is produced, it may be formed into various articles. The ethylene polymer is particularly suited for articles such as film products, caps and closures, rotomoulding, grass yarn, pressure/temperature resistant pipes etc.

The present invention therefore also encompasses an article comprising an ethylene polymer as defined herein; or obtained according to a process as defined herein. In some embodiments, the articles can be film products, caps and closures, rotomoulding, grass yarn, pressure/temperature resistant pipes etc.

Preferred embodiments for ethylene polymer of the invention are also preferred embodiments for the article of the invention.

The invention also encompasses a process for preparing an article according to the invention. Preferred embodiments as described above are also preferred embodiments for the present process.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES

### Test Methods

The properties cited herein and cited below were determined in accordance with the following test procedures. Where any of these properties is referenced in the appended claims, it is to be measured in accordance with the specified test procedure.

### Melt Flow Index

The melt flow index (MI₂) of ethylene polymers was determined according to ISO 1133:2005 Method B, condition D, at a temperature of 190° C., and a 2.16 kg load using a die of 2.096 mm.

The high load melt flow index (HLMI) of ethylene polymers was determined according to ISO 1133:2005 Method B, condition G, at a temperature of 190° C., and a 21.6 kg load using a die of 2.096 mm.

The melt flow index (HL275) of ethylene polymers was determined according to ISO 1133:2005 Method B, condition G, at a temperature of 190° C. and under a load of 21.6 kg except that a die of 2.75 mm was used.

### Molecular Weight, Molecular Distribution

The molecular weight (Mₙ (number average molecular weight), M_{w} (weight average molecular weight) and molecular weight distributions D (M_{w}/Mₙ), and D′ (M_{z}/M_{w}) were determined by size exclusion chromatography (SEC) and in particular by IR-detected gel permeation chromatography (GPC) at high temperature (145° C.). Briefly, a GPC-IR5MCT from Polymer Char was used: 8 mg polymer sample was dissolved at 160° C. in 8 mL of trichlorobenzene stabilized with 1000 ppm by weight of butylhydroxytoluene (BHT) for 1 hour (h). Injection volume: about 400 μl, automatic sample preparation and injection temperature: 160° C. Column temperature: 145° C. Detector temperature: 160° C. Column set: two Shodex AT-806MS (Showa Denko) and one Styragel HT6E (Waters), columns were used with a flow rate of 1 mL/min. Detector: Infrared detector (2800-3000 cm-1) to collect all C—H bonds and two narrow band filters tuned to the absorption region assigned to CH₃ and CH₂ groups. Calibration: narrow standards of polystyrene (PS) (commercially available). Calculation of molecular weight Mᵢ of each fraction i of eluted polymer is based on the Mark-Houwink relation (log₁₀(M_{PE})=0.965909×log 10(M_{PS})−0.28264) (cut off on the low molecular weight end at M_{PE}=1000).

The molecular weight averages used in establishing molecular weight/property relationships are the number average (Mₙ), weight average (M_{w}) and z average (M_{z}) molecular weight.

These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{\dot{i}} {h}_{i} / {M}_{i}} \\ {M}_{w} = \frac{{\sum }_{i} {N}_{i} {M}_{i}^{2}}{{\sum }_{i} {N}_{i} {M}_{\dot{i}}} = \frac{{\sum }_{i} {W}_{i} {M}_{i}}{{\sum }_{i} {W}_{i}} = \frac{{\sum }_{i} {h}_{i} {M}_{i}}{{\sum }_{i} {h}_{i}} \\ {M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mᵢ. The third representation in each case (farthest right) defines how one obtains these averages from SEC chromatograms. hi is the height (from baseline) of the SEC curve at the iₜₕ elution fraction and M; is the molecular weight of species eluting at this increment.

### Comonomer Content

The comonomer content, especially 1-hexene, (wt. % C6-) relative to the total weight of the ethylene polymer was determined from a ¹³C{¹H} NMR spectrum. Ethyl branches content, expressed in terms of equivalent wt. % C4-, was also determined from a ¹³C{¹H} NMR spectrum.

The sample was prepared by dissolving a sufficient amount of polymer in 1,2,4-trichlorobenzene (TCB 99% spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as internal standard. To give an example, about 220 mg of polymer were dissolved in 2.0 mL of TCB, followed by addition of 0.5 mL of C₆D₆ and 2 to 3 drops of HMDS.

¹³C{¹H} NMR signal was recorded on a Bruker 500 MHz with a 10 mm probe (or 10 mm cryoprobe) with the following conditions:
Pulse angle: 90°
Pulse repetition time: 30 s
Spectral width: 25000 Hz centered at 95 ppm
Data points: 64K
Temperature: 130° C.+/−2° C.
Rotation: 15 Hz
Scan numbers: 2000-4000 (240 scans with 10 mm cryoprobe)
Decoupling sequence: inverse-gated decoupling sequence to avoid NOE effect
¹³C{¹H} NMR spectrum was obtained by Fourier Transform on 131K points after a light Gaussian multiplication. Spectrum was phased, baseline corrected, and chemical shift scale was referenced to the internal standard HMDS at 2.03 ppm.

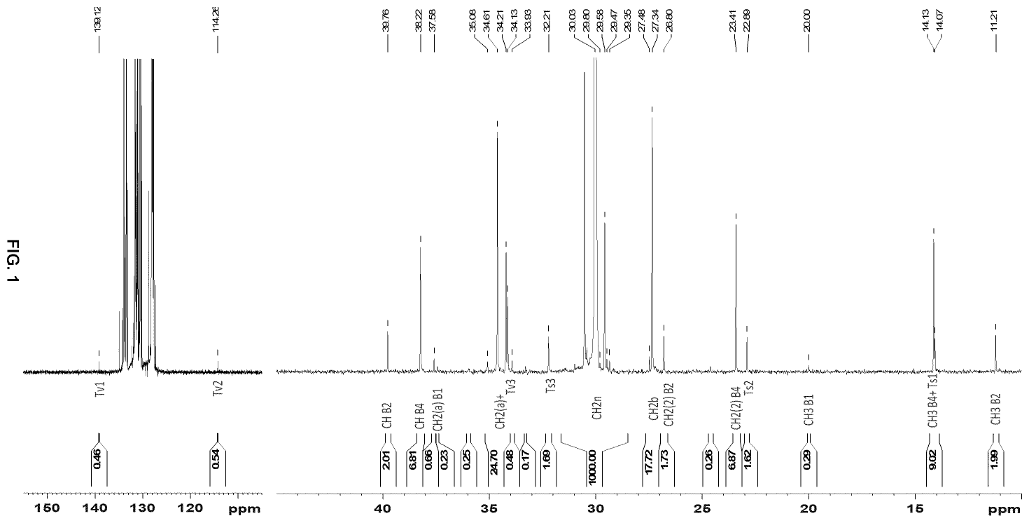

Chemical shifts of signals were peak picked, and peaks were integrated as mentioned on FIG. 1 and in the following Table A.

TABLE A
integration regions of ¹³C{¹H} NMR spectrum

| | Peak position | High Integral limit | Low Integral limit |
|---|---|---|---|
| | (ppm) | (ppm) | (ppm) |
| Vinylidene 1 | 150.13 | 150.2 | 149.98 |
| Tv1 | 139.13 | 139.18 | 139.05 |
| Tv2 | 114.26 | 114.34 | 114.19 |
| Vinylidene 2 | 108.96 | 109.05 | 108.85 |
| CH2 | 40.3 | 40.45 | 40.2 |
| CH B2 | 39.76 | 39.88 | 39.61 |
| CH B4 | 38.22 | 38.4 | 38.03 |
| CH2(a) B1 | 37.58 | 37.7 | 37.5 |
| CH B4 high | 35.97 | 36.05 | 35.86 |
| CH2(a)+ | | 35.2 | 34 |
| Tv3 | 33.93 | 34 | 33.8 |
| CH B1 | 33.29 | 33.3 | 33.23 |
| Ts3 | 32.21 | 32.35 | 32.07 |
| CH2n | 30.03 | 31.6 | 28.49 |
| CH2(b) | 27.34 | 27.66 | 26.96 |
| CH2 (2) B2 | 26.8 | 26.96 | 26.62 |
| CH2 | | 24.71 | 24.48 |
| CH2(2) B4 | 23.41 | 23.55 | 23.2 |
| Ts2 | 22.89 | 23.02 | 22.79 |
| CH3 B1 | 20 | 20.06 | 19.92 |
| CH3 B4 + Ts1 | 14.1 | 14.32 | 13.86 |
| CH3 B2 | 11.21 | 11.34 | 11.06 |

Small adjustments on integration limits can be applied if necessary.

Chemical shifts are given at ±0.05 ppm.

The wt. % C6- and wt. % C4- contents are obtained by the following areas (A) combinations:

$${A}_{C 3} = 0.5 \times {A}_{CH 2 ( a ) B 1} {A}_{C 4} = {A}_{CH 3 B 2} {A}_{C 6} = {A}_{CH 2 ( 2 ) B 4} {A}_{C 2} = 0.5 \times ( {A}_{T v 1} + {A}_{T v 2} + {A}_{T v 3} + {A}_{Vinylidene 1 +} {A}_{Vinylidene 2} + 0.5 \times {A}_{CH 2 ( a ) B 1} + {A}_{Ts 3} + 2 \times {A}_{Ts 2} + {A}_{CH 2 n} - {A}_{C 6} + {A}_{CH 2 ( b )} ) \\ wt . \% C 6 ‐ = ( 84 * {A}_{C 6} ) / ( 28 * {A}_{C 2} + 42 * {A}_{C 3} + 56 * {A}_{C 4} + 84 * {A}_{C 6} ) \times 100 \\ wt . \% C 4 ‐ = ( 56 * {A}_{C 6} ) / ( 28 * {A}_{C 2} + 42 * {A}_{C 3} + 56 * {A}_{C 4} + 84 * {A}_{C 6} ) \times 100 \qquad ( 2 )$$

### Meso/Rac Ratio of Metallocene Catalyst

The meso/rac ratio of catalyst component A was determined from ¹H NMR spectrum.

The sample was prepared by dissolving a few dozen mg of solid complex in 0.5 mL of anhydrous methylene chloride (CD₂Cl₂, spectroscopic grade) at room temperature.

¹H NMR signal was recorded on a Eruker 400 MHz with a 5 mm probe with the following conditions:
Pulse angle: 90°
Pulse repetition time: 60 s
Spectral width: 6000 Hz centered at 5.5 ppm
Data points: 32K
Temperature: 25° C.+/−1° C.
Rotation: 20 Hz
Scan numbers: 8

¹H NMR spectrum was obtained by Fourier Transform on 32K points after a light exponential multiplication. Spectrum was phased, baseline corrected, and chemical shift scale was referenced to the CH₂CL₂ peak at 5.33 ppm.

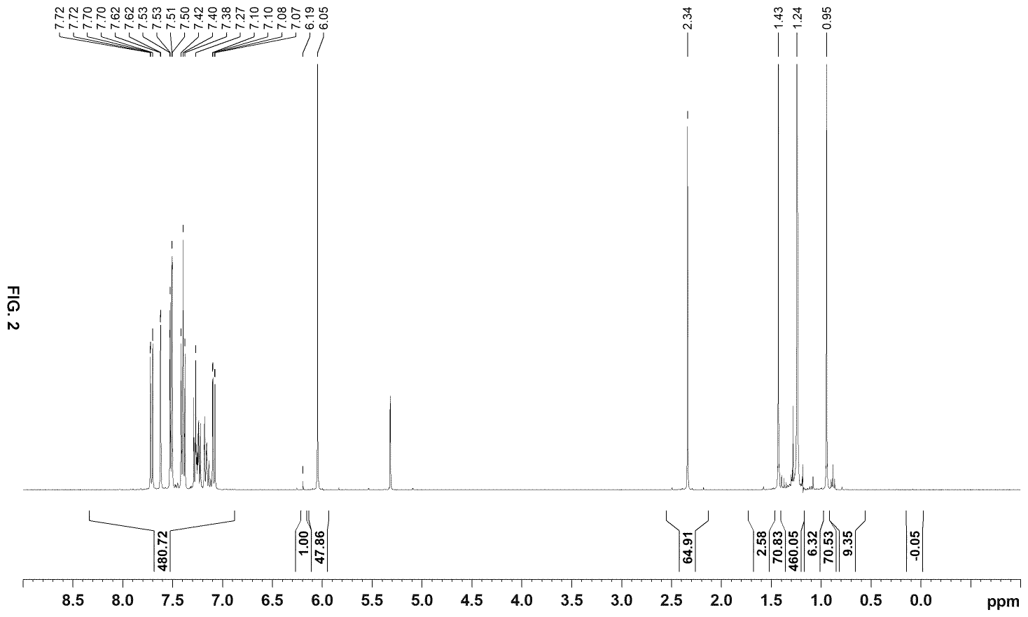

Chemical shifts of signals were peak picked, and peaks were integrated as mentioned on FIG. 2 and in the following Table B. PGP-41 T1

TABLE B
integration regions of ¹H NMR spectrum

| | Peak position | High Integral limit | Low Integral limit |
|---|---|---|---|
| | (ppm) | (ppm) | (ppm) |
| Rac | 6.19 | 6.21 | 6.16 |
| Meso | 6.05 | 6.13 | 5.93 |

The meso/rac ratio was obtained by the following areas (A) combination:

Meso/Rac=A_{Meso}/A_{Rac}

### Comonomer Distribution

Co-monomer distribution illustrated by the CH₃/CH₂ ratio across the molecular weight distribution was also determined using the SEC apparatus described above equipped with an integrated high-sensitivity multiple band IR detector (IR5-MCT) as described by A. Ortin et al. (Macromol. Symp. 330, 63-80 2013 and T. Frijns-Bruls et al. Macromol. Symp. 356, 87-94 2015).

The comonomer distribution can be determined by the ratio of the IR detector intensity corresponding to the CH₃ and CH₂ channels calibrated with a series of PE homo/copolymer standards whose nominal value were predetermined by NMR.

The detector produced separate and continuous streams of absorbance data, measured through each of their IR selective filters CH₃ and CH₂ at a fixed acquisition rate of one point per half second. The detector was equipped with a heated flow-through cell of 13 μL internal volume.

The ratio of infra-red absorbance band ratio A_{CH3} to A_{CH2} (methyl over methylene sensitive channels) can be correlated to the methyl (CH₃) per 1000 total carbons (1000TC), denoted as CH₃/1000TC, as a function of molecular weight.

The IR CH₃/CH₂ ratio of the polymer was obtained by considering the entire signals of the CH₃ and CH₂ channels between the integration limits of the concentration chromatogram: IR ratio=Area of CH₃ signal within integration limits/area of CH₂ signal within integration limits. In the present invention, an increase of the area ratio CH₃/CH₂ means an increase in Short Chain Branching content.

### Determination of Al and Zr Contents

The Al and Zr contents were determined using inductively coupled plasma atomic emission spectroscopy (ICP-AES) after mineralization of the sample and recovery of the residues in an acid medium. The spectrometer used was ICP-AES ARCOS, by Spectro.

The determination of the elements was carried out by nebulization of the solution in an argon plasma, measurement of the intensities of the most sensitive and interference-free emission lines and comparison of these intensities with those of calibration solutions (external calibration method).

Preparation of the solution to be analyzed (test solution): Under an inert atmosphere (in a glove box), about 0.3 g of catalyst were added into a platinum crucible and 3 to 5 mL of isopropyl alcohol were added to “deactivate” the catalyst. The mixture was heated to dryness in a sand bath (30 min). The platinum crucible was placed in an oven at 600° C. for 10 min. After cooling, Milli-Q® deionized water was added to impregnate all the ashes, and 1 mL of concentrated HCl (Merck HCl 32% v/v) and concentrated HF (Merck HF 48% v/v) were added. The crucible was placed in a sand bath, and Milli-Q® deionized water was added to mix the content of the crucible. After 24 h, 1 mL of concentrated HCl, 0.5 mL of concentrated HF and Milli-Q® deionized water were added while agitating the mixture under heat to achieve full dissolution. After cooling the mixture was transferred to a 50 mL polypropylene tube and the volume made up to 50 mL with Milli-Q® deionized water. The test solutions were then diluted 25 times ensuring that 2% HCl/HF1% medium was maintained.

Preparation of calibration standards and control solutions: Standard solutions were prepared by dilution of commercial single-element solutions of certified concentrations. The standard solutions were prepared by transferring the required volume of the certified solution to a 50 mL polypropylene tube, then rinsing the sides of the tube with Milli-Q® deionized water, and adding 1 mL of concentrated HCl and 0.5 mL of concentrated HF per 50 mL to obtain the same acid content in solution as in the sample solutions, and finalizing the dilution with Milli-Q® deionized water. Control solutions were prepared by dilution of commercial multi-element solutions of certified concentrations. The presence of other elements in solution allowed verification of the presence/absence of possible interferences.

### Expression of Results:

THE content (in ppm) of the element measured in the sample was calculated as follows:

$$\frac{\begin{matrix}Concentration in mg / l of the element in solution \times \\ Volume ( 50 mL ) \times Dilution factor\end{matrix}}{Mass ( g )}$$

The Limit of Quantification (LOQ) was calculated for each element from 10 blank measurements:

LOQ in solution (mg/l)=standard deviation of 10 replicates of the blank×10

$$LOQ in sample ( ppm ) = \frac{LQ in solution \times Volume ( 50 mL ) \times Dilution factor}{Mass ( g )}$$

### Catalysts

Metallocene 1: Meso-Metallocene 1 (mMet1)

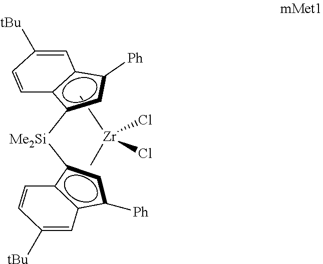

Meso-Metallocene 1 (mMet1) was prepared as described below and as shown under Scheme 1. Unless otherwise mentioned, all procedures take place in a glovebox under a nitrogen atmosphere using dry solvents.

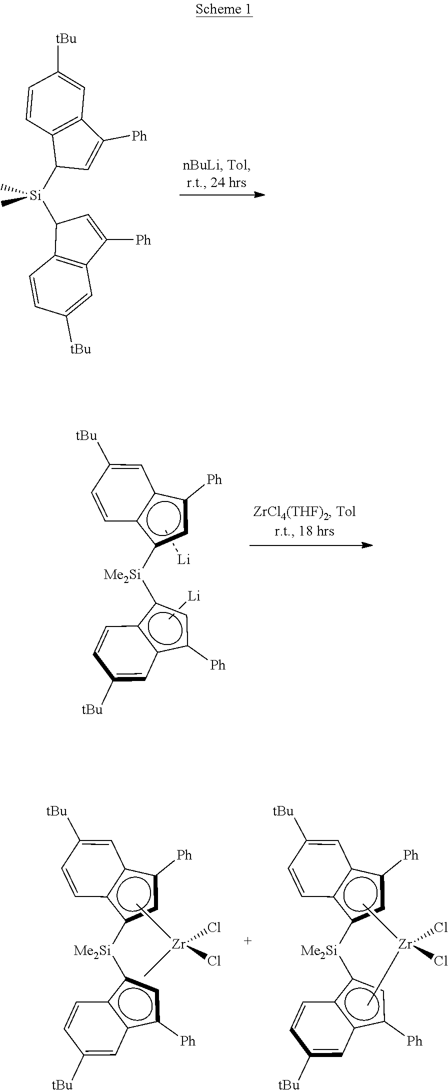

### Step 1:

To a solution of 3.52 g (0.022 mol) of diethyl malonate in 25 mL of THF, 0.88 g (60% in oil, 0.022 mol) of sodium hydride was added at 0° C. This mixture was refluxed for 1 h and then cooled to room temperature. Next, 5 g (0.022 mol) of 4-tBu-benzylbromide was added, and the resulting mixture was refluxed for 3 h. A precipitate formed (NaBr). This mixture was cooled to room temperature and filtered through a glass frit (G2). The precipitate (NaBr) was additionally washed with 3×5 mL of THF. The combined filtrates were evaporated to dryness.

The residue was dissolved in 20 mL of ethanol and 2.5 mL of water were added then 8 g of potassium hydroxide at 0° C. The resulting mixture was refluxed for 2 h, and then 10 mL of water was added. Ethanol was distilled off under reduced pressure and controlled T° C. (max 30° C.). The resulting aqueous solution was acidified with HCl to pH 1 and the product was extracted with ether (3×100 mL). The combined organic fractions were washed with HCl 1 M (1×25 mL) and brine (1×25 mL) then dried over MgSO₄ and concentrated under reduced pressure.

The dibasic acid was decarboxylated by heating for 2 h at 160° C. (a gas evolution is noticed). The product obtained was dissolved in 30 mL of dichloromethane, and 30 mL of SOCl₂ was added. The mixture was refluxed for 3 h and then evaporated to dryness.

The residue was dissolved in 12 mL of dry dichloromethane, and the solution obtained was added dropwise to a suspension of 6.5 g (0.05 mol) of AlCl₃ in 68 mL of dichloromethane for 1 h at 0° C., while vigorously stirring. Next, the reaction mixture was refluxed for 3 h, cooled to room temperature, poured on 250 cm³ of ice, and extracted with DCM (3×50 mL).

The organic layer was washed with HCl 1M and brine (1×25 mL each). The combined organic fractions were dried over MgSO₄ and then evaporated to dryness. The product was isolated by filtration over silica (1 to 10% AcOEt in isopentane). The desired product was a yellow oil (Yield=35%).

### Step 2:

6-tBu-1-indanone (1 eq., 5.078 g) was dissolved in 80 mL of Et₂O. PhMgBr (1.1 eq., 10 mL, 3M) was added at 0° C. dropwise and the solution was heated at reflux during 2 h and then stirred overnight at room temperature. After overnight stirring, the reaction was slowly quenched with 50 mL of 1 M HCl and stirred during 1 h. The mixture was neutralized with saturated solution of NaHCO₃ and extracted with diethyl ether (×2). The organic layer was dried with magnesium sulfate and the solvent was removed by rotary evaporation. The product was isolated as a slightly yellow oil (6.54 g, 95%) and used directly in the next step without further purification (or in some cases a filtration over silica with n-pentane was performed).

### Step 3:

2 g (8 mmol) of 6-tBu-(phenyl)-1-indene were introduced into 50 mL of diethyl ether, and 5.3 mL of n-butyllithium (1.6 M in hexane) were added dropwise at 0° C. After this addition was complete, the mixture was stirred at room temperature overnight. A catalytic amount of CuCN was added and the resulting solution was stirred during 30 min then 0.49 mL of (dimethyl)dichlorosilane (4 mmol) were added in one portion. After this addition, the reaction solution was stirred overnight at room temperature. The reaction mixture was filtered through alumina and the solvent was removed in vacuo. The product was purified by silica gel flash column chromatography with hexane/DCM (9/1) as eluent to obtain an orange powder. Yield=52%.

### Step 4:

To a solution of ligand bis(5-tert-butyl-3-phenyl-1H-inden-1-yl)-dimethyl-silane (9.7 g, 552.8 g/mol, 0.0176 mol) in 130 mL of toluene (500 mL round-bottom flask) was added n-BuLi (1.6 M in hexanes, 22.0 mL, 0.0351 mol) over the course of 15 min. The mixture was left to stir at room temperature for 24 h. In a second 500 mL round-bottom flask, ZrCl₄ (4.1 g, 233.04 g/mol, 0.0176 mol) was suspended in 50 mL toluene. With stirring, THF (tetrahydrofuran, 2.7 g, 72.11 g/mol, 0.0370 mol) was added dropwise over ca. 5 min. This reaction mixture was left to stir at room temperature for 2 h. The ligand/n-BuLi mixture was then added via pipette over the course of 15 min to the ZrCl₄/THF mixture. An extra ca. 2 mL of THF was used to wash the white solid off the walls of the ligand/n-BuLi flask, and ensure complete transfer. The resulting mixture was left to stir at room temperature for 18 h and then filtered over a 75 mL POR3 glass frit packed with Celite (dried in the oven for 3 days prior to use). The reaction flask and Celite was washed with an extra 40 mL toluene. The filtrate was concentrated under vacuum to ca. 200 mL. The flask was well sealed using silicone grease and a glass stopper, shipped out of the glovebox, and stored at −35° C. for 20 h. The flask was then left at room temperature to de-frost prior to returning to the glovebox. The mixture was filtered over a 75 mL POR4 glass frit, collecting a bright orange solid and a red-orange filtrate. The solid was washed with 2×3 mL of pentane, then dried on the frit for ca. 1.5 h. The solid was then transferred to a vial for storage: fraction 1, 2.58 g (21% yield). The filtrate was concentrated under vacuum in a 500 mL round-bottom flask until an orange precipitate began to form. The flask was sealed with a greased stopper, shipped out of the glovebox, and stored at −35° C. for 20 h. The flask was de-frosted at room temperature, returned to the glovebox, and the mixture was filtered over a POR4 glass frit, collecting a second fraction of bright orange solid and an orange filtrate. The solid was washed with 2×3 mL pentane and was left to dry under vacuum on the frit for 2 h. The solid was then transferred to a vial for storage: fraction 2, 446 mg (4% yield). The same procedure as indicated above was repeated for the filtrate at this point, allowing a third (942 mg, 8% yield) fraction of orange solid to be isolated.

The meso purity of each fraction was determined by 1H NMR. Based on these results, it was concluded that fractions 1 and 2 had similar meso purities and could be combined, resulting in an overall yield of 25% Met1 with 96% meso purity (i.e., meso/rac ratio of the meso form of Met1 is 96:4) (¹H NMR of the catalyst is shown in FIG. 2). This metallocene is referred as mMet1 and is used without further purification for supporting and polymerization described herein.

### Metallocene 2:

rac-Cyclohexyl(methyl)silanediylbis[2-methyl-4-(4′-tert-butylphenyl)indenyl]zirconium dichloride (Met2) was purchased from SPCI (South Pacific Chemical Industries) (CAS 888227-55-2).

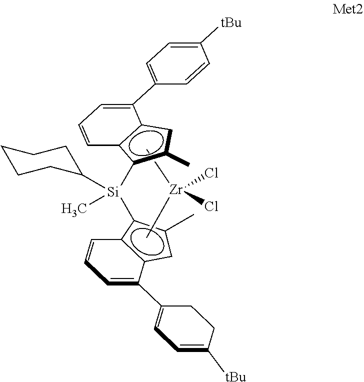

### Metallocene 3:

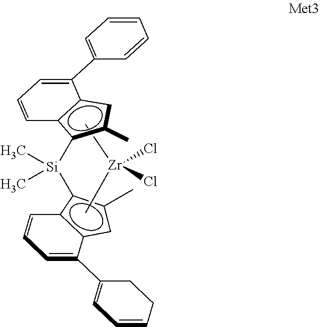

rac-dimethylsilanediyl-bis[(2-methyl-4-phenyl)-indenyl]₂ zirconium dichloride (Met3) was purchased from Grace. (CAS 153882-67-8).

### Synthesis of Supported Catalysts:

All catalyst and co-catalyst experimentations were carried out in a glove box under nitrogen atmosphere. Methylaluminoxane (30 wt. %) (MAO) in toluene from Albemarle was used as the activator. Titanated silica from PQ (PD12052) was used as catalyst support (D50: 25 μm).

Supported metallocene catalysts were prepared in two steps using the following method:

### 1. Impregnation of MAO on Silica:

Ten grams of dry silica (dried at 450° C. under nitrogen during 6 h) was introduced into a round-bottomed flask equipped with a mechanical stirrer and a slurry was formed by adding 100 mL of toluene. MAO (21 mL) was added dropwise with a dropping funnel. The reaction mixture was stirred at 110° C. for 4 h. The reaction mixture was filtered through a glass frit (POR3) and the powder was washed with dry toluene (3×20 mL) and with dry pentane (3×20 mL). The powder was dried under reduced pressure overnight to obtain a free-flowing grey powder.

### 2. Deposition of Metallocene on Silica/MAO Support:

Silica/MAO (10 g) was suspended in toluene (100 mL) under nitrogen. Metallocene components A and B (total A+B=200 mg) were introduced and the mixture was stirred 2 h at room temperature. The reaction mixture was filtered through a glass frit and the powder was washed with dry toluene (3×20 mL) and with dry pentane (3 times). The powder was dried under reduced pressure overnight to obtain a free-flowing grey powder.

The samples were analyzed for zirconium and aluminum content (wt. %) using ICP-AES spectroscopy (Inductively Coupled Plasma-Atomic Emission Spectroscopy). The results are shown in Table 1.

TABLE 1

| Catalyst composition (weight ratio) | wt. % Al | wt. % Zr |
|---|---|---|
| mMet1/Met2 (50/50) | 16 | 0.18 |
| mMet1/Met2 (30/70) | 14 | 0.19 |
| mMet1/Met2 (20/80) | 15 | 0.21 |
| mMet1/Met2 (10/90) | 15 | 0.21 |

### Polymerizations 1

Polymerization reactions were performed in a 132 mL autoclave with an agitator, a temperature controller, and inlets for feeding of ethylene and hydrogen. The reactor was dried at 110° C. with nitrogen for 1 h and then cooled to 40° C.

All polymerizations were performed under the heterogenous conditions depicted in Table 2 (unless otherwise stated). The reactor was loaded with 75 mL of isobutane, 1.6 mL of 1-hexene (C6-) and pressurized with 23.8 bar of ethylene (C2-) with 800 ppm of hydrogen. Catalyst (3.5 mg) was added. Polymerization started upon catalyst composition suspension injection, was performed at 85° C. and was stopped after 60 min by reactor depressurization. Reactor was flushed with nitrogen prior opening. The polymer fluff obtained at the end was then analyzed.

TABLE 2

| Conditions | Unit | Reactor |
|---|---|---|
| Isobutane (iC4) | L | 0.075 |
| Triisobutylaluminum (TIBAL) | ppm | 100 |
| 1-hexene (C6—) | wt. %* | 2.44 |
| Hydrogen (H₂) | ppm | 800** |
| Temperature | ° C. | 85 |
| Ethylene pressure | bar | 23.8 |

*In comparison to iC4
**In ethylene feed

The results of the co-polymerization of ethylene with 1-hexene as comonomer in the presence of mMet1/Met2 dual catalyst compositions with varying weight ratio of each catalyst are shown in Table 4. The polymerization conditions were the same as listed in Table 2.

TABLE 4

| Catalyst | | | | | | | | |
|---|---|---|---|---|---|---|---|---|
| Composition | Activity | MI₂ | HLMI | Mₙ | M_{w} | M_{z} | | |
| (weight ratio) | g/g/h | g/10 min | g/10 min | kDa | kDa | kDa | M_{w}/Mₙ | M_{z}/M_{w} |
| mMet1/Met2 | 7680 | 0.9 | — | 14.7 | 116 | 792 | 7.9 | 6.9 |
| (50/50) | | | | | | | | |
| mMet1/Met2 | 6818 | — | 5.6 | 15.3 | 151 | 943 | 9.9 | 6.2 |
| (30/70) | | | | | | | | |
| mMet1/Met2 | 4924 | — | 9.1 | 19.8 | 213 | 1130 | 10.8 | 5.3 |
| (20/80) | | | | | | | | |
| mMet1/Met2 | 8348 | — | ND | 27.5 | 253 | 915 | 9.2 | 3.6 |
| (10/90) | | | | | | | | |

ND: not determined

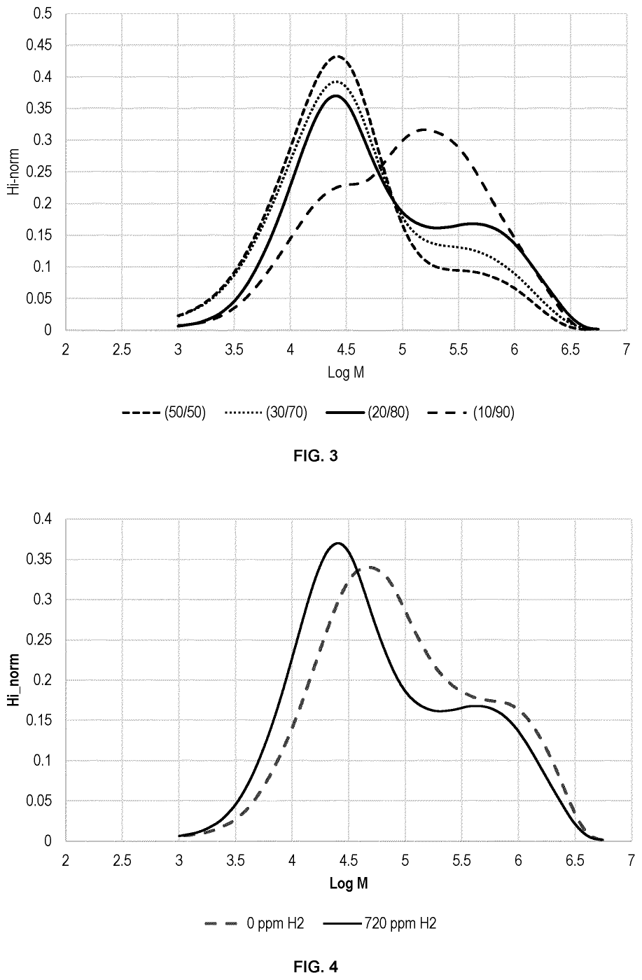

FIG. 3 shows the GPC trace of the polymers obtained with dual catalyst composition mMet1/Met2 having different catalyst ratio (from 50/50 to 10/90 mMet1/Met2 weight ratio).

The hydrogen response was also studied for catalyst composition with 20/80 mMet1/Met2 weight ratio. The polymerization conditions were the same as listed in Table 2, except for the hydrogen concentration. The results are shown in Table 5 and FIG. 4.

TABLE 5

| H₂ | Activity | MI₂ | HLMI | Mₙ | M_{w} | M_{z} | | |
|---|---|---|---|---|---|---|---|---|
| ppm | g/g/h | g/10 min | g/10 min | kDa | kDa | kDa | M_{w}/Mₙ | M_{z}/M_{w} |
| 0 | 5036 | | ND | 27.3 | 271 | 1230 | 9.9 | 4.6 |
| 720 | 4924 | ND | 9.1 | 19.8 | 213 | 1130 | 10.8 | 5.3 |

ND: not determined

### Polymerizations 2

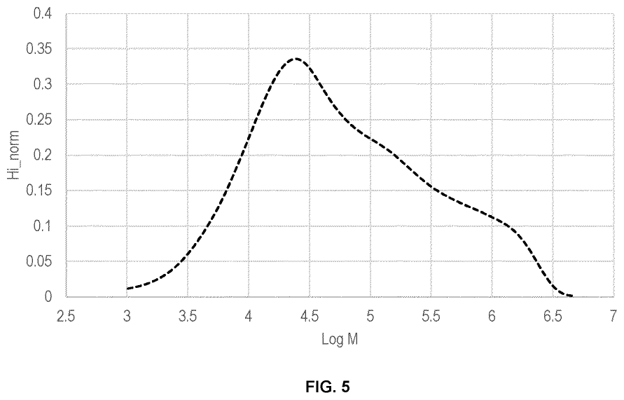

Further polymerization reactions were performed using catalyst composition mMet1/Met3 (20/80 weight ratio) (2.12 mg), using the condition of Table 2. Results are detailed in Table 6, and GPC results are plotted in FIG. 5.

TABLE 6

| Activity | HL275 | Mₙ | M_{w} | M_{z} | | |
|---|---|---|---|---|---|---|
| g/g/h | g/10 min | kDa | kDa | kDa | M_{w}/Mₙ | M_{z}/M_{w} |
| 5840 | 0.21 | 19 | 200 | 1047 | 10.6 | 5.2 |

1-15. (canceled)

16. A catalyst composition comprising:
catalyst component A comprising the meso form of a bridged metallocene compound of formula (Ia); wherein 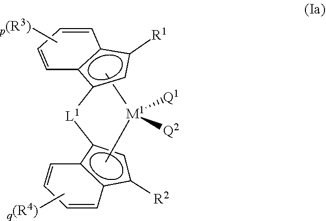
each of R¹, and R³, are independently selected from the group comprising alkyl, alkenyl, cycloalkyl, cycloalkenyl, cycloalkenylalkyl, aryl, alkoxy, alkylaryl, arylalkyl, halogen, Si(R¹⁰)₃, and heteroalkyl; wherein at least one of R¹ or R³ is aryl, wherein one R¹ is on position 3 and/or one R³ is on position 5 of each indenyl, wherein each R¹⁰ is independently hydrogen, alkyl, or alkenyl; and p is an integer selected from 0, 1, 2, 3, or 4;
each of R², and R⁴, are independently selected from the group comprising alkyl, alkenyl, cycloalkyl, cycloalkenyl, cycloalkenylalkyl, phenyl, alkoxy, alkylaryl, arylalkyl, halogen, Si(R¹⁰)₃, and heteroalkyl; wherein at least one of R² or R⁴ is aryl, wherein one R² is on position 3 and/or one R⁴ is on position 5 of each indenyl, wherein each R¹⁰ is independently hydrogen, alkyl, or alkenyl; and q is an integer selected from 0, 1, 2, 3, or 4;
L¹ is SiR⁸R⁹, —[CR⁸R⁹]ₕ—, GeR⁸R⁹, or BR⁸; wherein h is an integer selected from 1, 2, or 3;
each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl;
M¹ is a transition metal selected from the group comprising zirconium, titanium, hafnium, and vanadium; and preferably M is zirconium; and
Q¹ and Q² are each independently selected from the group comprising halogen, alkyl, —N(R¹¹)₂, alkoxy, cycloalkoxy, aralkoxy, cycloalkyl, aryl, alkylaryl, aralkyl, and heteroalkyl;
wherein R¹¹ is hydrogen or alkyl;
wherein the meso rac ratio of the meso form of the bridged metallocene compound of catalyst component A is 95:5 or greater, as determined using ¹H NMR;
catalyst component B comprising a bridged metallocene compound with two indenyl groups, each indenyl being independently substituted with one or more substituents, wherein at least one of the substituents is an unsubstituted or substituted aryl or heteroaryl; and wherein the unsubstituted or substituted aryl or heteroaryl substituent is not on position 3 and/or 5 of the indenyl, preferably each indenyl has one or more substituents on positions 2 and/or 4 of each indenyl; and
an optional activator; an optional support; and an optional co-catalyst.

17. The composition according to claim 16, wherein catalyst component A comprises the meso form of bridged metallocene of formula (Ib) 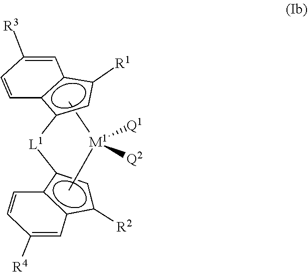
wherein R¹, R², R³, R⁴, L¹, M¹, Q¹, Q², have the same meaning as that defined in claim 16.

18. The composition according to claim 16, wherein catalyst component B comprises a bridged metallocene of formula (II), wherein 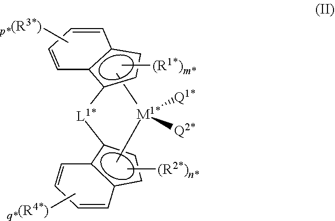
each of R^{1*}, and R^{3*}, are independently selected from the group comprising alkyl, alkenyl, cycloalkyl, cycloalkylalkyl, cycloalkenyl, cycloalkenylalkyl, aryl, alkoxy, alkylaryl, arylalkyl, halogen, Si(R¹⁰)₃, and heteroalkyl; wherein each of said group can be unsubstituted or substituted with one or more substituents each independently selected from the group comprising alkyl, alkenyl, cycloalkyl, cycloalkylalkyl, alkoxy, halogen, haloalkyl; wherein at least one of R^{1*} or R^{3*} is unsubstituted or substituted aryl, wherein R^{1*} is not in position 3 and/or R^{3*} is not on position 5 of each indenyl, wherein each R¹⁰ is independently hydrogen, alkyl, aryl, or alkenyl; and m*, p*, are each independently an integer selected from 0, 1, 2, 3, or 4, wherein at least one of m* or p* is at least 1;
each of R^{2*}, and R^{4*}, are independently selected from the group comprising alkyl, alkenyl, cycloalkyl, cycloalkylalkyl, cycloalkenyl, cycloalkenylalkyl, phenyl, alkoxy, alkylaryl, arylalkyl, halogen, Si(R¹⁰)₃, and heteroalkyl; wherein each of said group can be unsubstituted or substituted with one or more substituents each independently selected from the group comprising alkyl, alkenyl, cycloalkyl, cycloalkylalkyl, alkoxy, halogen, haloalkyl; wherein at least one of R^{2*} or R^{4*} is unsubstituted or substituted aryl, wherein R^{2*} is not in position 3 and/or R^{4*} is not on position 5 of each indenyl, wherein each R¹⁰ is independently hydrogen, alkyl, aryl, or alkenyl; and n*, q* are each independently an integer selected from 0, 1, 2, 3, or 4, wherein at least one of n* or q* is at least 1;
L^{1*} is SiR⁸R⁹, —[CR⁸R⁹]ₕ—, GeR⁸R⁹, or BR⁸; wherein h is an integer selected from 1, 2, or 3; each of R⁸, and R⁹ are independently selected from the group comprising hydrogen, alkyl, alkenyl, cycloalkyl, cycloalkenyl, cycloalkenylalkyl, aryl, aminoalkyl, and arylalkyl; or R⁸ and R⁹ together with the atom to which they are attached form a cycloalkyl, cycloalkenyl or heterocyclyl;
M^{1*} is a transition metal selected from the group comprising zirconium, titanium, hafnium, and vanadium; and preferably M^{1*} is zirconium; and
Q^{1*} and Q^{2*} are each independently selected from the group comprising hydrogen, halogen, hydroxyl, alkyl, alkenyl, —N(R¹¹)₂, —SR¹¹, alkoxy, cycloalkoxy, aralkoxy, cycloalkyl, aryl, aryloxy, alkylaryl, aralkyl, and heteroalkyl; wherein R¹¹ is hydrogen or alkyl or aryl.

19. The composition according to claim 18, wherein catalyst component B comprises a bridged metallocene of formula (IIa), 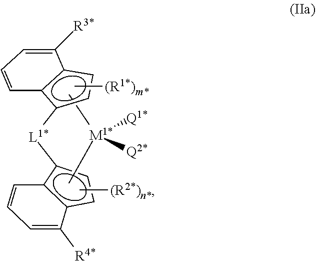
wherein R^{1*}, R^{2*}, R^{3*}, R^{4*}, L^{1*}, M^{1*}, Q^{1*}, Q^{2*}, m* and n* have the same meaning as that defined in claim 18.

20. The composition according to claim 18, wherein catalyst component B comprises bridged metallocene of formula (IIb) 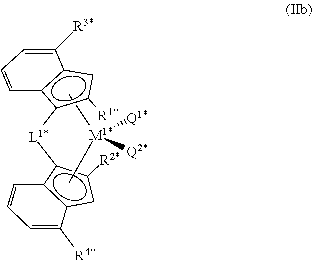
wherein R^{1*}, R^{2*}, R^{3*}, R^{4*}, L^{1*}, M^{1*}, Q^{1*}, Q^{2*}, have the same meaning as that defined in claim 18.

21. The composition according to claim 16, wherein catalyst components A and B are provided on a single solid support.

22. The composition according to claim 16, wherein the weight ratio of catalyst component A to catalyst component B is in a range of from 10/90 to 90/10, preferably in the range of from 10/90 to 80/20, preferably in the range of from 10/90 to 70/30, preferably in the range of from 10/90 to 50/50, preferably in the range of from 10/90 to 40/60.

23. The composition according to claim 16, wherein the catalyst composition comprises an activator, preferably wherein the activator comprises an aluminoxane compound, an organoboron or organoborate compound, an ionizing ionic compound, or any combination thereof; preferably wherein the activator is methyl alumoxane.

24. The composition according to claim 16, wherein the catalyst composition comprises a co-catalyst, preferably an organoaluminum cocatalyst, preferably selected from the group comprising trimethylaluminum, triethylaluminum, tri-n-propylaluminum, tri-n-butylaluminum, triisobutylaluminum, tri-n-hexylaluminum, tri-n-octylaluminum, diisobutylaluminum hydride, diethylaluminum ethoxide, diethylaluminum chloride, and any combination thereof.

25. The composition according to claim 16, wherein the support comprises a solid oxide, preferably, the solid oxide comprises titanated silica, silica, alumina, silica-alumina, silica-coated alumina, aluminum phosphate, aluminophosphate, heteropolytungstate, titania, zirconia, magnesia, boria, zinc oxide, a mixed oxide thereof, or any mixture thereof.

26. An olefin polymerization process, the process comprising: contacting a catalyst composition according to claim 16 with an olefin monomer, optionally hydrogen, and optionally one or more olefin comonomers; and polymerizing the monomer, and the optionally one or more olefin comonomers, in the presence of the at least one catalyst composition, and optional hydrogen, thereby obtaining a polyolefin.

27. An olefin polymer at least partially catalyzed by at least one catalyst composition according to claim 16.

28. An olefin polymer produced by the process according to claim 26.

29. An article comprising the olefin polymer according to claim 27.

30. An article comprising the olefin polymer according to claim 28.
